(19) United States
(12) Patent Application Publication
(10) Pub. No.: US 2026/0105761 A1
(43) Pub. Date: Apr. 16, 2026

(54) HEAT MAP-BASED FACIAL FEATURE KEY POINT OCCLUSION DETECTION FOR OCCUPANT MONITORING SYSTEMS AND APPLICATIONS

(71) Applicant: NVIDIA Corporation, Santa Clara, CA (US)

(72) Inventors: Shagan SAH, Santa Clara, CA (US); Nishant PURI, San Francisco, CA (US); Rajath Bellipady SHETTY, Sunnyvale, CA (US); Zhengmin ZHANG, Santa Clara, CA (US)

(21) Appl. No.: 18/915,958

(22) Filed: Oct. 15, 2024

(51) Int. Cl. G06V 20/59; G06V 40/16

(52) U.S. Cl. CPC G06V 20/597; G06V 40/171

(57) ABSTRACT

In various examples, heat map-based facial feature key point occlusion detection for occupant monitoring systems and applications is disclosed. Facial feature key points may be detected and evaluated on an individual basis using a facial feature key point estimation model trained to generate confidence heat map estimations of a set of facial feature key point locations from an image of an occupant. Based on a confidence heat map, the model may predict both a facial feature key point location and an occlusion score for that facial feature key point indicating an estimate of a likelihood that the facial feature key point is occluded. In some embodiments, the facial feature key point estimation model may be further trained to perform an occlusion classification that predicts a type occlusion that is obscuring a predicted facial feature key point.

### BACKGROUND

Occupant monitoring may be used within a vehicle cabin to perform real-time assessments of driver and occupant presence, gaze, alertness, or other conditions. For example, occupant monitoring system (OMS) sensors may be used to track the direction of a driver's eye gaze, head pose, or blinking (for example to detect drowsiness, fatigue, and/or distraction), for hand position and/or gesture detection, child and/or pet presence detection, and/or in conjunction with the operation of features such as, but not limited to, seat belt reminders, seat heating, and/or smart airbag deployment. The ability to draw accurate conclusions from OMS sensor data is at least in part determined by the ability to identify and track facial feature key points from images of an occupant.

### SUMMARY

Embodiments of the present disclosure relate to heat map-based facial feature key point occlusion detection for occupant monitoring systems and applications. Systems and methods are disclosed that relate to detecting and tracking features (e.g., facial features) when regions of an occupant (e.g., an occupant's face) captured by occupant monitoring system (OMS) sensors are obstructed.

In contrast to conventional systems—such as those described above—embodiments of the present disclosure provide for heat map-based feature key point occlusion detection where feature key points are detected and evaluated on an individual basis using a feature key point estimation model trained to generate confidence heat map estimations of a set of feature key point locations from an image of an occupant. Based on a confidence heat map, the model may predict both a feature key point location and an occlusion score for that feature key point indicating an estimate of a likelihood that the feature key point is occluded.

In some embodiments, the feature key point estimation model is a facial feature key point estimation model, and may localize facial feature key points based on a version of an argmax function. The argmax function is a mathematical function that returns the index of the maximum value in a set of values. In the context of a deep neural network (DNN), the argmax function may be used to select a most likely class or output from a set of possibilities—that is, the class with the largest predicted probability. That is, during the estimation, each feature key point is treated as an individual 2-dimensional class map (e.g., with pixels that may be mapped to pixel locations of the input image), which can also be interpreted as a heat map. The function of the soft argmax layer is to determine the peak in this heat map to find the location of a feature key point. In addition to identifying the peak of an individual feature key point heat map, the extent of a spread of the heat map carries information about how confident the model is in localizing the facial feature key point estimation model. For example, a feature key point heat map may comprise a 2D Gaussian distribution where the peak probability of the Gaussian distribution provides the estimated location of the feature key point, and the standard deviation of the Gaussian distribution provides an indication of whether the feature key point is occluded that can be normalized to an occlusion score for that feature key point.

In some embodiments, the feature key point estimation model may further be trained to perform an occlusion classification that predicts a type of occlusion that is obscuring a predicted feature key point. That is, the feature key point estimation model may infer from the image a class of the object obscuring the feature key point. In some embodiments, the classifications may include a first class that indicates that a feature key point is being obscured by an object located between the occupant and the OMS camera (e.g., a cell phone, sunglasses, an eye patch, a mask, hair, a shirt collar, a hat, etc.) or otherwise occluded due to glare, reflections, and/or poor lighting conditions. The classifications may include a second class that indicates that a feature key point is being self-occluded (e.g., obstructed by the occupant's face itself due to the pose of the occupant). Examples of self-occlusion include, but are not limited to, a nose being occluded by a forehead or cheeks, eyes being occluded by eyebrows or eyelids, and a mouth being occluded by a nose or chin. In some embodiments, the classifications may include a third class that indicates that a feature key point is occluded because it is located outside the field of view of the OMS camera and therefore is not observable from the captured image. Such classification may be used by downstream systems (e.g., gaze detection, head pose detection, driver drowsiness, etc.) using the output of the feature key point estimation model to determine how and/or whether to use the predicted feature key point location predictions produced by the feature key point estimation model from a given captured image. When no occlusion is detected, the occlusion classification may include a class that indicates that no occlusion is present. By addressing the challenges of self-occlusion and object occlusion as described herein, facial key point estimation algorithms based on embodiments disclosed herein are more robust and accurate, enabling a wide range of applications in computer vision, machine learning, and human-computer interaction.

### BRIEF DESCRIPTION OF THE DRAWINGS

The present systems and methods for heat map-based facial feature key point occlusion detection for occupant monitoring systems and applications are described in detail below with reference to the attached drawing figures, wherein:

FIG. 1 is a data flow diagram for an example facial feature key point prediction system vehicle, in accordance with some embodiments of the present disclosure;

FIGS. 2A, 2B, and 2C are example facial feature key point heat maps, in accordance with some embodiments of the present disclosure;

FIG. 3 is a diagram illustrating an example training architecture for training a facial feature key point estimation model, in accordance with some embodiments of the present disclosure;

FIGS. 4A, 4B, and 4C are diagrams illustrating examples of facial feature key point location data and/or occlusion classifications predicted by a facial feature key point estimation model, in accordance with some embodiments of the present disclosure;

FIGS. 5A and 5B are diagrams illustrating an example facial image auto-labeling process using a facial feature key point estimation model, in accordance with some embodiments of the present disclosure;

FIG. 6 is a flow diagram showing an example method for facial feature key point occlusion detection, in accordance with some embodiments of the present disclosure;

FIG. 7A is an illustration of an example autonomous vehicle, in accordance with some embodiments of the present disclosure;

FIG. 7B is an example of camera locations and fields of view for the example autonomous vehicle of FIG. 7A, in accordance with some embodiments of the present disclosure;

FIG. 7C is a block diagram of an example system architecture for the example autonomous vehicle of FIG. 7A, in accordance with some embodiments of the present disclosure;

FIG. 7D is a system diagram for communication between cloud-based server(s) and the example autonomous vehicle of FIG. 7A, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

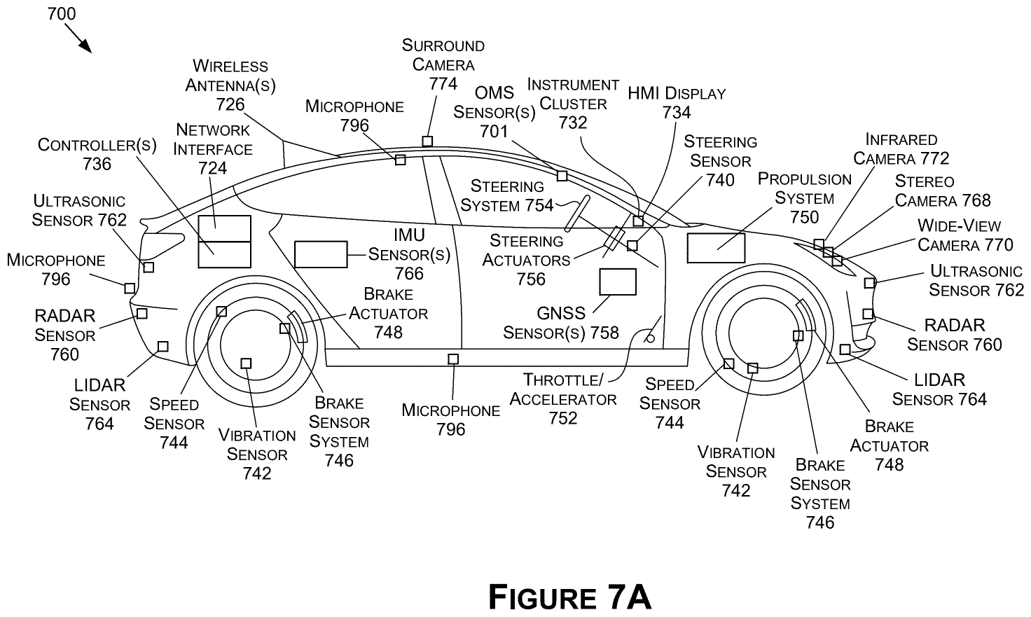

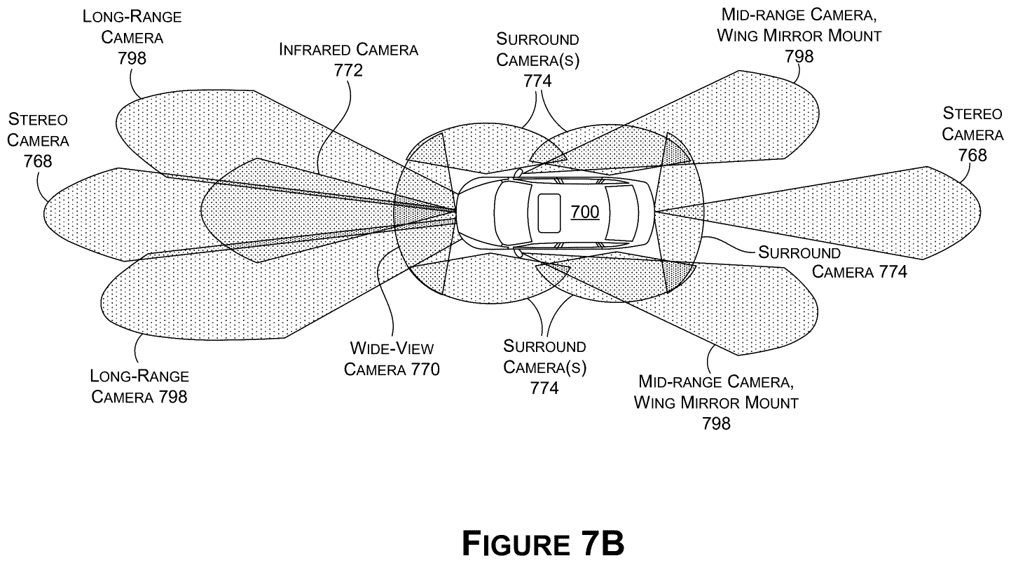

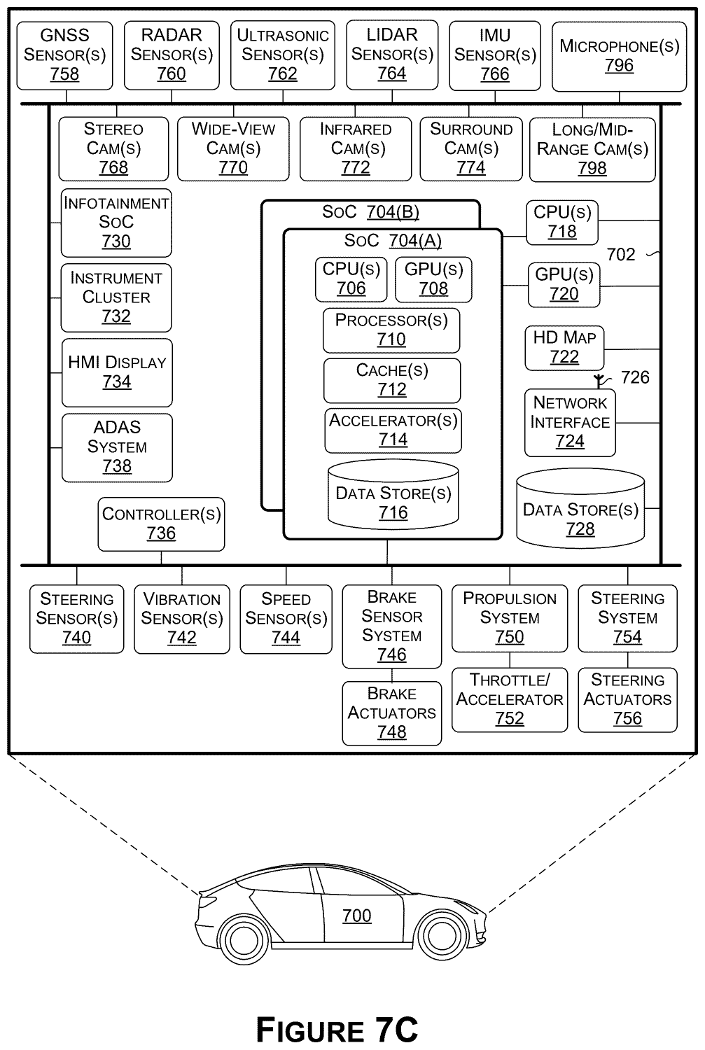

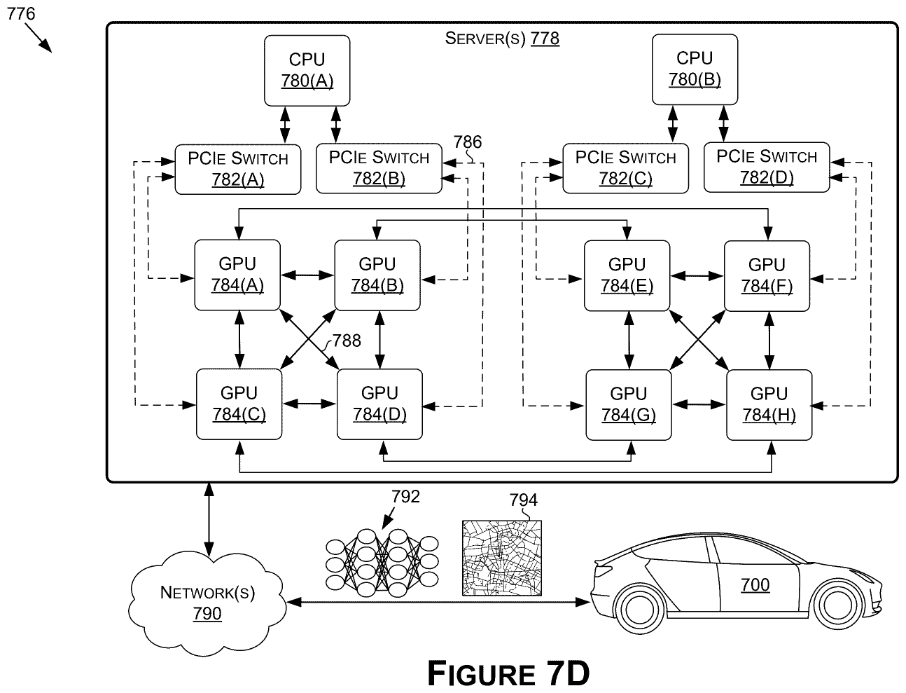

Systems and methods are disclosed related to heat map-based facial feature key point occlusion detection for occupant monitoring systems and applications. Although the present disclosure may be described with respect to an example autonomous or semi-autonomous vehicle or machine 700 (alternatively referred to herein as “vehicle 700” or “ego machine 700,” an example of which is described with respect to FIGS. 7A-7D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to vehicle occupant monitoring systems, this is not intended to be limiting, and the systems and methods described herein may be used in augmented reality, virtual reality, mixed reality, robotics, security and surveillance, autonomous or semi-autonomous machine applications, and/or any other technology spaces where human body feature key points may be used.

The present disclosure relates to vehicle occupant monitoring technologies. More specifically, the systems and methods presented in this disclosure relate to detecting and tracking facial features when regions of an occupant's face captured by occupant monitoring system (OMS) sensors are obstructed.

Machine learning-based (e.g., facial) feature key point estimation models represent one technology for detecting feature key points from images and video. For example, Deep Neural Networks (DNNs) may be trained to input images and predict the locations of feature key points (e.g., features of the eyes, nose, mouth, and/or jawline of an occupant) with high accuracy and robustness, by extracting relevant features such as edges, corners, shapes, and textures. Such models are often trained using very large datasets of annotated facial images from which the models learn to generalize facial feature key point detection to new, unseen faces having variations in pose, expression and illumination.

However, feature key point estimation models may be challenged to identify feature key points from images where parts of the subject's face are occluded, inhibiting the model from extracting features from those regions of an input image. As non-limiting examples, parts of an occupant's face may be occluded by: hair, eye glasses, masks, facial hair, hands and fingers, shadows, reflections (e.g., reflections from other surfaces can produce reflections or glare in a captured image that make it difficult to detect facial key points), and/or pose variations (e.g., self-occlusion, where parts of the face are occluded by other facial features, such as when an occupant turns their head).

Occlusions can lead to detection errors from the feature key point estimation model (e.g., where key points may be mis-detected or not detected), inaccurate key point location estimates (e.g., where imprecisely estimated key points may not accurately represent the occupant's true facial structure), and robustness issues with respect to consistency in performance with respect to different drivers and/or lighting conditions. Furthermore, inaccurate or unreliable data from the facial feature key point estimation model may have consequences for other processes that use facial key point estimates from the model. For example, drowsiness detection functions may operate based on facial key points marked on a driver's pupils as reliable indicators of whether the driver's eyes are open or closed and/or to detect blink rates. Blockage of these facial key points may inhibit drowsiness detection functions from accurately assessing driver drowsiness leading to a loss of critical safety features.

To address these challenges, various techniques have been proposed. One approach uses multiple views or cameras to capture a subject (e.g., a subject's face) from different angles, reducing the impact of occlusions. However, this approach relies on complex processing of multiple streams of images, the need for accurate extrinsic calibration between cameras, and the added costs associated with needed multiple cameras, and does not address instances where a complete set of key points may still not be available due to obstructions. For facial key points—for example and without limitation, these obstructions could be due to the positions of hair, masks, glasses, hand positions, relative to the camera with respect to the key points. Other approaches attempt to evaluate an image to identify when a face is at least partially obstructed, and assign a face-level occlusion score to the image. For example, a face-level occlusion score may be computed that indicates a scale of the occlusion (e.g., 5%, 50%, 90%, etc.) and a threshold established for using the image. An image with a face-level occlusion score below the threshold may be discarded, while an image with a face-level occlusion score above the threshold may be considered acceptable for use. However, in the case of a discarded image, that image may still comprise one or more clearly observable facial feature key points that could be useable for some applications (e.g., a face obstructed by a hand may still have valid eye pupil facial feature key points usable for drowsiness detection). Conversely, an accepted image with a face-level occlusion score may still comprise one or more occluded facial feature key points that may reduce the accuracy or reliability of inference made from that image.

Still other approaches optimize and/or fit observable facial feature key points to a three-dimensional (3D) head model, and predict when one or more facial feature key points are obscured due to head rotation. However, those approaches remain susceptible to occlusions that may block otherwise observable facial feature key points on a region of a face exposed to the camera—which may in turn compromise the accuracy of the head model optimization, thus degrading the accuracy of the entire set of facial feature key point estimate.

In contrast to these prior technologies, embodiments of this disclosure provide for heat map-based feature key point occlusion detection for occupant monitoring systems and applications. More specifically, facial feature key points are detected and evaluated on an individual basis using a facial feature key point estimation model trained to generate confidence heat map estimations of a set of facial feature key point locations from an image of an occupant. Based on a confidence heat map, the model may predict both a facial feature key point location (e.g., a set of image pixel coordinates) and an occlusion score for that facial feature key point indicating an estimate of a likelihood that the facial feature key point is occluded. In some embodiments, the facial feature key point estimation model may comprise a deep neural network (DNN) architecture, such as a convolutional neural network (CNN), recurrent neural network (RNN), or other DNN-based model. As discussed herein, the facial feature key point estimation model may be trained using a loss function designed to optimize the key point occlusion score predictions.

In some embodiments, the facial feature key point estimation model may compute facial feature key point localizations based on a version of an argmax function. The argmax function is a mathematical function that returns the index of the maximum value in a set of values. In the context of a DNN, the argmax function may be used to select a most likely class or output from a set of possibilities—that is, the class with the largest predicted probability. For example, a soft argmax layer is a type of layer used in DNNs that computes a soft version of the argmax function (e.g., a smooth approximation to the argmax function). The soft argmax layer is a differentiable version of the argmax function, which means that it can be used as a layer in a DNN and trained using backpropagation. In some embodiments, a soft argmax layer in the facial feature key point estimation model may be used for class activation mapping. That is, during the estimation, each facial feature key point is treated as an individual 2-dimensional class map (e.g., with pixels that may be mapped to pixel locations of the input image) which can also be interpreted as a heat map. The function of the soft argmax layer is to determine the peak in this heat map to find the location of a facial feature key point.

For example, for a selected facial feature key point (e.g., an outer corner of the occupant's left eye), the facial feature key point estimation model may input a facial image (which may be a cropped version of a full image captured by an OMS camera) and compute a heat map having coordinates that may be mapped to the facial image. For pixel locations at a substantial distance from the given facial feature key point, the value of the pixels may be at or near zero, indicating that the model has a low confidence that this pixel is at the location of the selected facial feature key point. However, for locations on the heat map in close proximity to the selected facial feature key point, the facial feature key point estimation model may compute higher confidence values, with the heat map location(s) having the highest confidence values corresponding to the locations that the facial feature key point estimation model predicts most confidently are the locations of the selected facial feature key points. The facial feature key point estimation model may output that peak confidence location (e.g., in pixel location x, y coordinates) as the prediction of where the selected facial feature key point appears in the facial image, and may output the confidence values it computed for that prediction. In some embodiments, the facial feature key point estimation model may output a composite key point heat map comprising multiple data channels at each pixel location, with each data channel corresponding to a particular facial feature key point (e.g., left eye outer corner, left eye inner corner, left eye pupil center, right eye outer corner, right eye inner corner, right eye pupil center, left mouth corner, right mouth corner, and so forth).

With embodiments of this disclosure, in addition to identifying the peak of an individual facial feature key point heat map, the extent of a spread of the heat map carries information about how confident the model is in localizing the facial feature key point estimation model. For example, a facial feature key point heat map may comprise a 2D Gaussian distribution, where the peak probability of the Gaussian distribution provides the estimated location of the facial feature key point, and the standard deviation of the Gaussian distribution provides an indication of whether a facial feature key point that is occluded can be normalized to an occlusion score for that facial feature key point. That is, for a visible and easily distinguishable facial feature key point, the spread of the predicted facial feature key point heat map should be relatively narrow, with the facial feature key point estimation model producing a heat map that has a substantially high peak confidence such that a closely spaced collection of pixels corresponds to the facial feature key point, with the confidence values rapidly falling towards zero with increasing distance from the peak. Such a distribution would have a relatively small standard deviation. In contrast, when a facial feature key point is occluded, the facial feature key point estimation model may still produce a heat map that indicates a peak value used to predict an estimated location of the facial feature key point. However, for an occluded facial feature key point, the facial feature key point estimation model will not be able to detect the facial feature key point from the image with any substantial degree of confidence, and will lean more on its training of where that particular facial feature key point should be. As such, the distribution of the predicted facial feature key point heat map is spread over a relatively greater range of pixels and the Gaussian distribution is relatively flatter as compared to a non-occluded facial feature key point. As such, the standard deviation (or similar distribution statistic) may be used to compute a normalized occlusion score (e.g., a range of zero to one, where a score of zero indicates a low probability of occlusion and a score of one indicates a high probability of occlusion). Accordingly, the facial feature key point estimation model may produce an occlusion score for each of the facial feature key points for which a facial feature key point heat map is predicted.

In some embodiments, the facial feature key point estimation model may further be trained to perform an occlusion classification that predicts a type of occlusion that is obscuring a predicted facial feature key point. For example, in some embodiments, when the occlusion score for a facial feature key point exceeds an occlusion score threshold, the facial feature key point estimation model may infer from the image a class of the object obscuring the facial feature key point. In some embodiments, the classifications may include a first class that indicates that a facial feature key point is being obscured by an object located between the occupant and the OMS camera (e.g., a cell phone, eye glasses, an eye patch, a mask, hair, a shirt collar, a hat, etc.) or otherwise occluded due to glare, reflections, and/or poor lighting conditions. The classifications may include a second class that indicates that a facial feature key point is being self-occluded (e.g., the facial feature key point is being obstructed by the occupant's face itself due to the pose of the occupant). Examples of self-occlusion include, but are not limited to, the nose is occluded by the forehead or cheeks, the eyes are occluded by the eyebrows or eyelids, and the mouth is occluded by the nose or chin. In some embodiments, the classifications may include a third class that indicates that the facial feature key point is occluded because it is located outside the field of view of the OMS camera and therefore is not observable from the captured image. Such classification may be used by downstream systems (e.g., gaze detection, head pose detection, driver drowsiness, etc.) using the output of the facial feature key point estimation model to determine how and/or whether to use the predicted facial feature key point location predictions produced by the facial feature key point estimation model from a given captured facial image. When no occlusion is detected, the occlusion classification may include a class that indicates that no occlusion is present.

By addressing the challenges of self-occlusion and object occlusion as described herein, facial key point estimation algorithms can become more robust and accurate, enabling a wide range of applications in computer vision, machine learning, and human-computer interaction.

With respect to training of the facial feature key point estimation model, in some embodiments, training data may be produced based on labeling ground truth images. For example, in some embodiments, facial feature key points may be marked on a set of facial images by human annotators that manually identify and annotate (e.g., label) facial feature key points such as the eyes, nose, mouth, and facial contours (e.g., which may individually be assigned a distinct key point identifier (ID) according to a set of standard key points). The human annotators may annotate a location of each facial feature key point, and for individual key points further annotate using an occlusion label. For example, an occlusion label may indicate whether a facial feature key point is: 1) visible (not occluded), 2) object-occluded, 3) self-occluded, or 4) a truncated occlusion (occluded due to being outside the bounds of the facial image). During training, the model is fed an input facial image and produces a key point heat map for each facial feature key point. From the key point heat map for each facial feature key point, the model determines the location (e.g., x, y coordinates) having a peak value to define the estimated location of that facial feature key point (e.g., using soft argmax). The model may compute the standard deviation of the key point heat map distribution to generate an occlusion score for that facial feature key point (e.g., a score from zero to one). A loss function may compare the model-predicted location for each of the individual key points against the corresponding ground truth locations of those individual key points (e.g., as labeled by the human annotators) and the misalignment used to compute a misalignment loss component of loss feedback used for iteratively adjusting the facial feature key point estimation model. A second component of the loss feedback may include an occlusion loss (e.g., a key point occlusion loss) based on the error between the model's occlusion score and occlusion classification, and the annotated occlusion label from the ground truth training data that predicts a type occlusion that is obscuring a predicted facial feature key point. The model is iteratively trained (e.g., thousands of iterations) on the training data samples and adjusted over the iterations to drive the feedback loss towards a minimum. In minimizing the losses, the model is driven to produce heat maps that are more distinctively either narrower or wider depending on the prediction. That is, for observable non-occluded facial feature key points, the model should produce heat maps that are narrow since the model should be able to be confident in discerning a precise location of where a key point is located, and similarly be confident in where it is not located. A narrow distribution produces a low standard deviation, and thus a low occlusion score. In contrast, for an occluded facial feature key point where an image of the facial feature itself is not observable, the model relies more heavily on training to infer where it predicts that facial feature key point should be, and is thus less confident in precisely estimating the facial feature key point location. The heat map for that key point thus comprises a wider distribution of lower confident scores, which results in a higher standard deviation, and thus a higher occlusion score.

In some embodiments, the occlusion classification attached to a particular facial feature key point may inform downstream systems that use the data how an estimated facial feature key point location can be used. For example, an OMS may apply data filtering. The OMS may determine that a predicted location for a facial feature key point with a high occlusion score and an occlusion classification indicating an object occlusion should be discarded (e.g., not used) or assigned a low weight since there is low confidence in the accuracy of the estimated location. An OMS may similarly determine that a predicted location for a facial feature key point with a high occlusion score and an occlusion classification indicating a truncated occlusion should be discarded (e.g., not used) or assigned a low weight since there is low confidence in the accuracy of the estimated location. In contrast, an OMS may determine that a predicted location for a facial feature key point with a high occlusion score and an occlusion classification indicating a self-occlusion may validly indicate a location of a key point obscured by a head pose and use that data together with non-occluded key points to predict face geometries, such as but not limited to, head pose tracking, gaze detection and tracking, and/or conditions such as driver alertness, and the like. The OMS or other system may use the combination of key point location, occlusion score, and/or occlusion classification data for other purposes. For example, based on this data, the OMS may detect when a driver is wearing infrared (IR) blocking sunglasses that are occluding the observability of eye pupil key points. Such a detection may be used to prompt the driver to take off those sunglasses, or make them aware of safety functions that may not be available while the sunglasses are being worn (e.g., gaze detection, blink detection, etc.). In some embodiments, facial feature key point occlusion detection as described herein may be used for applications beyond blockage, such as for fine-grained occlusion estimation, which may be used as an input for specific tasks such as drowsiness user adaptation for drowsiness detection OMS functions. Facial key points marked on the pupils may be used as an indicator if the eyes are open or closed—a reliable signal for detecting eye blinks and hence estimating if a driver is drowsy. In some embodiments, the OMS may request the driver to remove IR blocking sunglasses (or mask, or other article obscuring key points) for a finite duration of time as the OMS generates baseline data (e.g., baseline blink rate data), and then once the baseline is established, allows the driver to put the sunglasses back on—using the baseline data in conjunction with key point location estimates that may have higher occlusion scores because of the sunglasses. In some embodiments, pupil occlusion may be used as a signal for determining quantitative measure of eye open/close. For example, typical perclos (percentage closure) signals are thresholded by measures such as 80% eye closure, which may be derived through pupil visibility as a proxy.

In some embodiments, downstream systems may use occlusion and/or key point location data from the facial feature key point estimation model for diagnostic purposes. For example, a warning and/or other signal may be generated indicating that the OMS system is degraded when a threshold number of key points are consistently identified as occluded. For example, a degradation in the OMS may occur due to a camera blockage, incorrect camera placement or mounting, the presence of a foreign substance smeared onto the lens of the camera, and/or a camera out of position (e.g., knocked off its mounting), each of which may be detected as occlusions using the heat map-based facial feature key point occlusion detection described herein. In some embodiments, occlusion patterns may be evaluated to detect physiological differences in humans (e.g., a beard, application of facial makeup, etc.), and/or to further recognize occlusion types such as masks, eye patches, hats, helmets, and the like.

In some embodiments, occlusion and/or key point location data from the facial feature key point estimation model may be used for enhanced perspective-n-point (PnP)-based head pose estimation. For example, generally, a head pose may be estimated through a PnP-based head model fitting using a subset of facial feature key points. By performing key point level occlusion estimation, embodiments of the present disclosure permit an OMS to categorically select estimated facial feature key point locations that are found to be non-occluded to facilitate the prediction of a more robust head pose.

In some embodiments, another application for a facial feature key point estimation model relates to facial image auto-labeling techniques for developing training data. More particularly, the facial feature key point estimation model may be applied to a method to classify and label self-occluded facial feature key points from facial images. Facial feature key point datasets may comprise a combination of labeled ground truth 2D key points as well as 3D key points. In the 2D key point datasets, when an image depicts an extreme head pose (e.g., with the head turned to the left or right), for self-occluded key points (e.g., on the non-observable side of the face), the human annotator may assign the key point labels to locations along an edge of the image of the face—a labeling method referred to as a “collapsed points” technique. Models trained just on a 2D key point dataset do not learn to predict the location of self-occluded key points on the non-observable side of the face. Three-dimensional key point datasets refer to datasets that use 2D projections of 3D key points for key points that are self-occluded. That is, the human annotator may make an educated guess as to the location of a self-occluded key point and label the image by assigning a 2D projected location to that key point indicating a location that is projected onto the opposing side of the face. When a facial feature key point estimation model is trained on training data that includes samples from both 2D and 3D datasets, it may produce a first set of facial feature key point locations based on training from the 2D dataset, and a second set of facial feature key point locations based on training from the 3D dataset. If a facial image is inferred through such a model, corresponding non-occluded key point locations from the two sets of predicted key point locations would align. However, for head poses that cause one or more facial feature key points to become self-occluded, the occluded key point locations from the two sets of predicted key point locations would be different, with occluded key point locations from the first set (2D) being exhibited as collapsed points, and occluded key point locations from the second set (3D) being educated guesses learned based on training on projected 2D key point locations (e.g., it has learned to predict key point locations through the face). Accordingly, corresponding self-occluded key point locations from the two sets of predicted key point locations would not align—and may be substantially misaligned. As such, a model trained to predict key point locations using both sets of key points may be used to auto-label key point locations of non-occluded (those that align between sets) and self-occluded key points (those that are substantially misaligned between sets) in large datasets (e.g., to produce training datasets) without the need for human annotators. Human annotators may still be used to annotate truncation-occluded and/or object-occluded key point locations, which would constitute a substantially simpler labeling task that can be performed more quickly. Moreover, in some embodiments, the model may apply multi-class auto-labeling of facial feature key points, for example where a key point classified and labeled as being a self-occluded key point is further classified and labeled as having an object occlusion based on the detection of an object located between the occupant and the OMS camera.

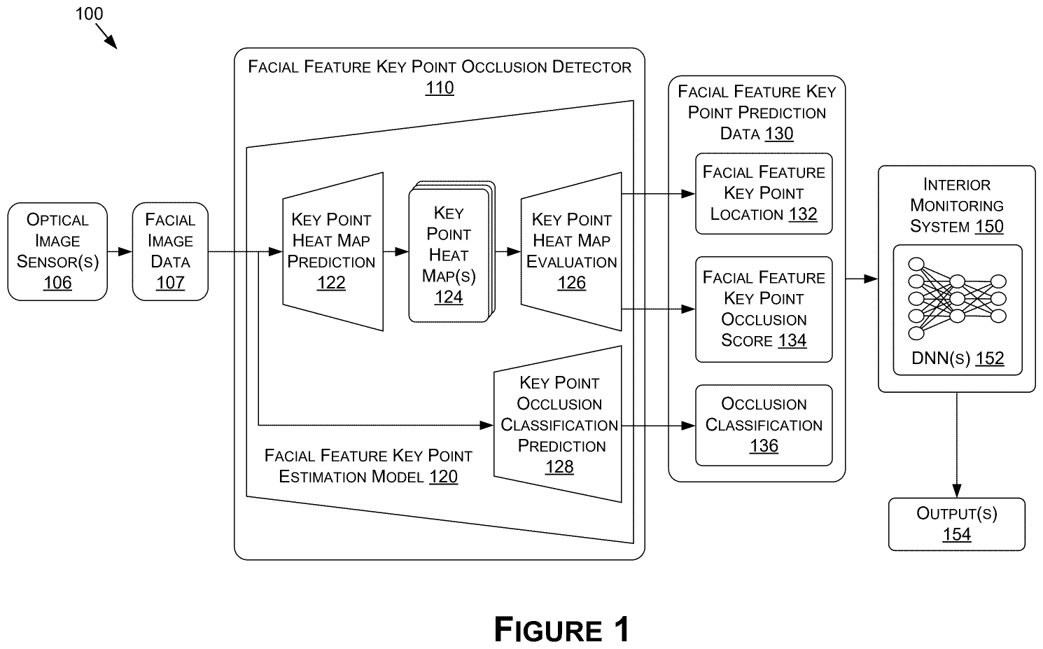

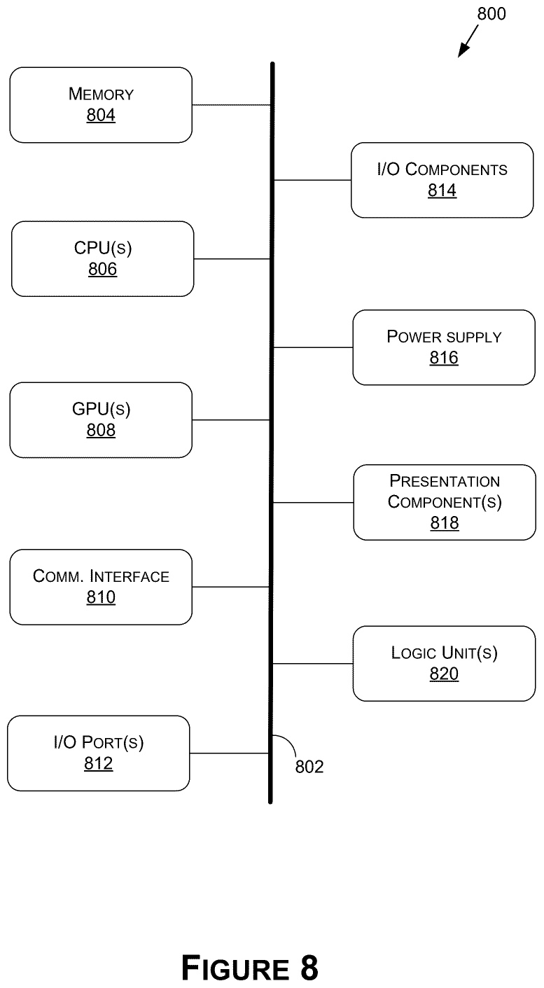

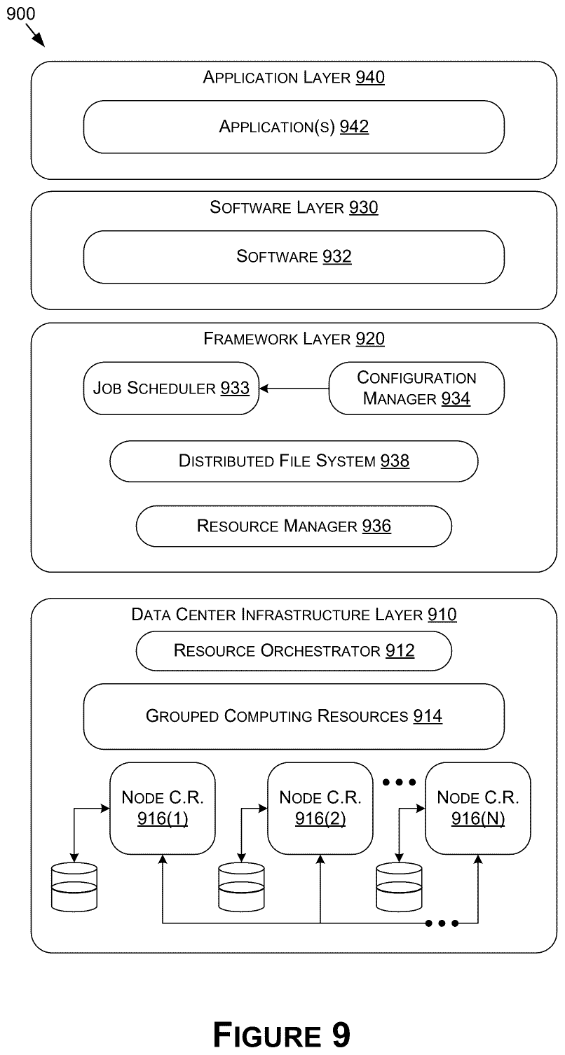

With reference to FIG. 1, FIG. 1 is an example data flow diagram of a process for a facial feature key point prediction system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 700 of FIGS. 7A-7D, example computing device 800 of FIG. 8, and/or example data center 900 of FIG. 9.

As shown in FIG. 1, a facial feature key point prediction system 100 may comprise a facial feature key point detector 110 that can generate facial feature key point prediction data 130 based on facial image data 107. The facial image data 107 may comprise one or more image frames that capture the face of a person, such as but not limited to a vehicle occupant. In some embodiments, the facial image data 107 may represent facial images that were cropped from larger images (e.g., cropped by a function of the facial feature key point prediction system 100 based on a bounding box that identifies the facial region of the person). In some embodiments, the facial image data 107 may comprise one or more image frames as captured by one or more optical image sensors 106. The optical image sensor(s) 106 may comprise, for example, one or more occupant monitoring system (OMS) sensor(s) 701 such as described with respect to the vehicle 700. In some embodiments, the facial image data 107 may be captured by an optical image sensor 106 comprising a camera, such as a red, green, blue (RGB), infrared (IR), and/or RGB-IR camera. In some embodiments, facial image data 107 may comprise facial images captured by different optical image sensors 106 at varied locations to capture facial data from different angles. In some embodiments, facial image data 107 may comprise simultaneously captured image frames from multiple optical image sensors 106 that are stitched together to form a composite image frame for input to the facial feature key point detector 110.

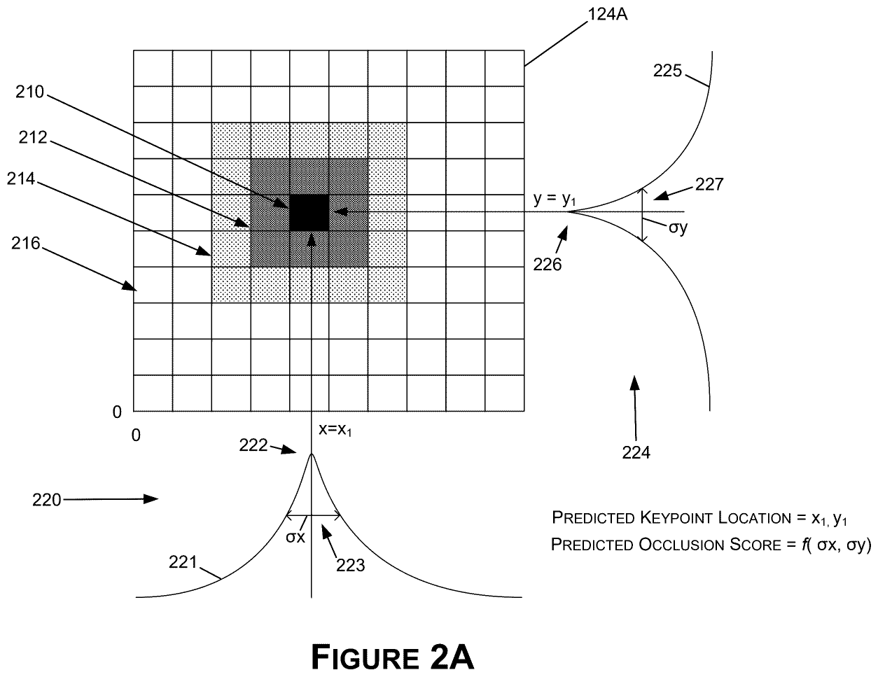

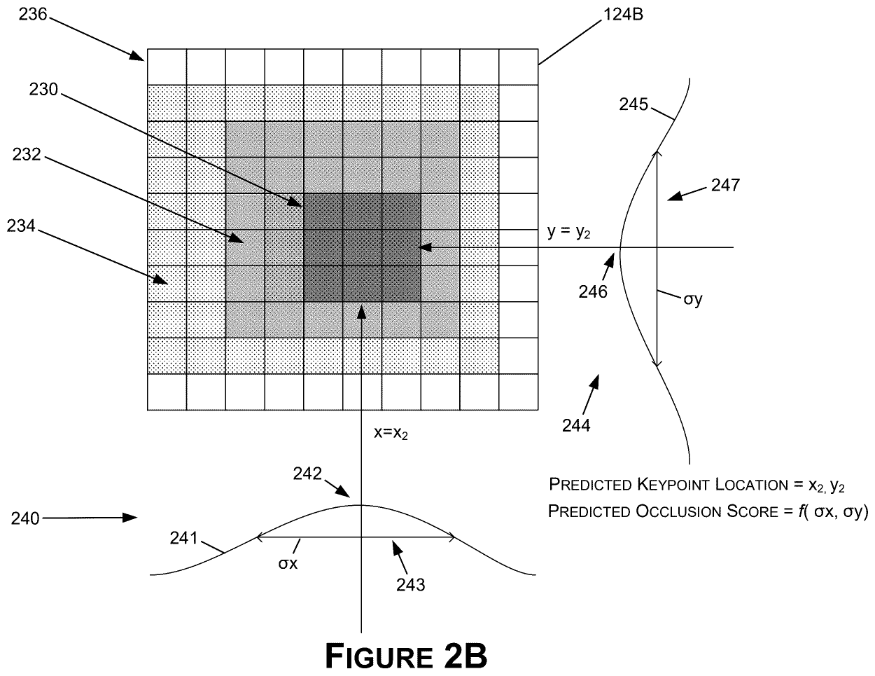

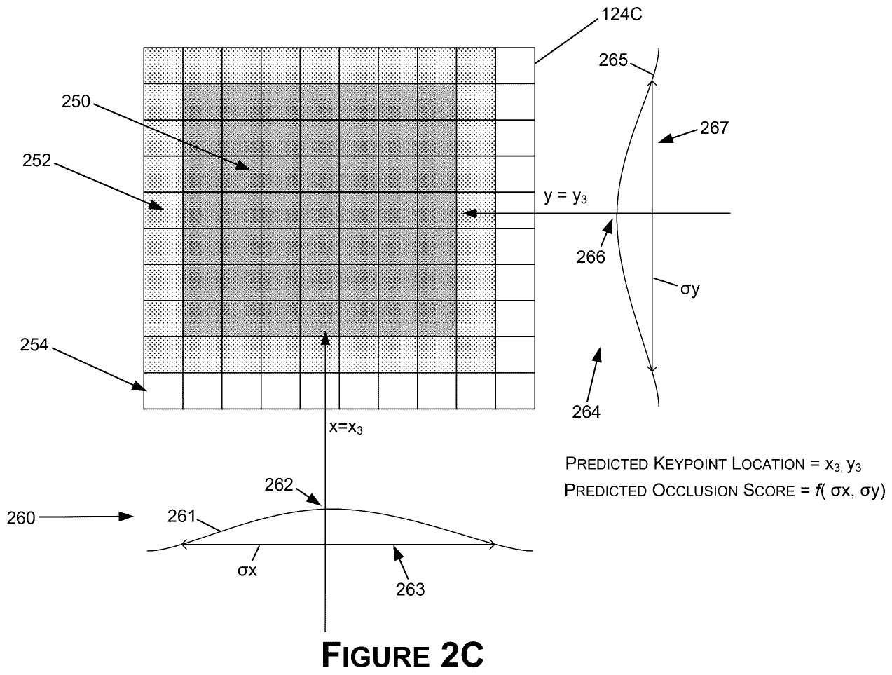

As shown in FIG. 1 and discussed herein, facial feature key point detector 110 may comprise a facial feature key point estimation model 120. The facial feature key point estimation model 120 comprises a neural network architecture, which may be implemented, for example, using one or more of a Convolutional Neural Network (CNN), Deep Neural Network (DNN), recurrent neural network (RNN), and/or other DNN-based model or machine learning model architecture(s). Based on the facial image data 107, the facial feature key point estimation model 120 may generate facial feature key point prediction data 130. More specifically, facial feature key points are detected and evaluated on an individual basis using a facial feature key point estimation model 120, which is trained to generate confidence heat map estimations of a set of facial feature key point locations from the facial image data 107. For example, as shown in FIG. 1, the facial feature key point estimation model 120 may comprise one or more layers that perform a key point heat map prediction 122 to generate one or more key point heat maps 124. The key point heat map prediction 122 may input the facial image data 107, and for one or more facial feature key points, compute the one or more key point heat maps 124. In some embodiments, key point heat map(s) 124 are generated that may be mapped on a pixel-by-pixel basis to frames of facial images from the facial image data 107. That is, key point heat map(s) 124 may comprise a plurality of data channels where each data channel corresponds to a particular facial feature key point (e.g., left eye outer corner, left eye inner corner, left eye pupil center, right eye outer corner, right eye inner corner, right eye pupil center, left mouth corner, right mouth corner, and so forth). The facial feature key point estimation model 120 may include key point heat map estimation evaluation 126 algorithms and/or key point occlusion classification prediction 128 algorithms (e.g., as described with respect to FIGS. 2A, 2B and 2C) for processing the key point heat map(s) 124 using to produce facial feature key point prediction data 130. In some embodiments, key point heat map estimation evaluation 126 and/or key point occlusion classification prediction 128 may be implemented using one or more neural layers of the facial feature key point estimation model 120. The facial feature key point prediction data 130 generated by the facial feature key point estimation model 120 may include, for one or more facial feature key points, a facial feature key point location 132, a facial feature key point occlusion score 134, and/or an occlusion classification 136. In some embodiments, a facial feature key point location 132, a facial feature key point occlusion score 134, and/or an occlusion classification 136 would define a set of facial feature key point prediction data 130 corresponding to a data channel of a key point heat map 124 associated with a particular facial feature key point. The facial feature key point estimation model 120 is trained to latently learn to identify what regions of the facial image to focus on to facilitate accurate key point predictions (e.g., static regions). Based on training, the facial feature key point estimation model 120 may infer potential facial feature key point locations and output key point heat map(s) 124 that may be aligned pixel-wise with the facial image data 107.

FIGS. 2A, 2B and 2C are diagrams illustrating key point heat map evaluation 126 for producing facial feature key point locations 132 and/or corresponding occlusion scores 134. For example, FIG. 2A is a diagram illustrating an example key point heat map 124A corresponding to a data channel of a key point heat map 124 for a non-occluded facial feature key point. In this example, the pixels of the heat map 124A within region 210 have pixel values representing the highest confidence values corresponding to a location that the facial feature key point estimation model 120 predicts most confidently as corresponding to the location of this facial feature key point. Here, the pixels within region 210 represent a clearly distinguishable peak in the distribution of confidence values, with the confidence values of pixels rapidly decreasing in neighboring region 212 and further in locations of region 214, approaching a near zero confidence value in region 216 of the key point heat map 124A. By applying the soft argmax function to the key point heat map 124A, the key point heat map estimation evaluation 126 may compute a predicted facial feature key point location 132 at heat map pixel coordinates x₁, y₁ that correspond to a peak confidence location. The predicted heat map pixel coordinates x₁, y₁ may be mapped to pixel coordinates of the facial image input to determine the facial feature key point location 132 within the facial image. With respect to the facial feature key point occlusion score 134, this value may be computed based on x-axis and y-axis distribution curves of confidence values of the key point heat map 124A, as illustrated at 220 and 224. As shown at 222, the x-axis distribution curve 221 comprises a well-defined peak at x=x₁, and a fairly narrow spread (distribution) 223 that may be characterized as the standard deviation, σₓ, of the x-axis distribution curve 221. As shown at 226, the y-axis distribution curve 225 comprises a well-defined peak at y=y₁, and a fairly narrow spread (distribution) 227 that may be characterized as the standard deviation, σ_{y}, of the y-axis distribution curve 225. A predicted facial feature key point occlusion score 134 may then be computed based on key point heat map 124A as: occlusion score=f(σₓ, σ_{y}) (e.g., occlusionscore=\sqrt{σₓ²+σ_{y}²}, or other statistical metric). Further, the facial feature key point estimation model 120 may use key point occlusion classification prediction 128 to infer an occlusion classification 136 based at least on the facial image data 107 and/or the facial feature key point occlusion score 134 (e.g., a visible (not occluded) key point classification for this particular example).

As another example, FIG. 2B is a diagram illustrating an example key point heat map 124B corresponding to a data channel of a key point heat map 124 for a facial feature key point that may be at least partially occluded, at least in close proximity to the facial feature key point. The pixels of the heat map 124B within region 230 have pixel values representing the highest confidence values corresponding to a location that the facial feature key point estimation model 120 predicts most confidently as corresponding to the location of this facial feature key point. In this example, the area of region 230 comprises lower confidence values spread over a larger region than that of region 210 of heat map 124A, indicating that the facial feature key point estimation model 120 is less confident about a precise location of this facial feature key point. The confidence values of pixels decrease in neighboring region 232 and further decrease in locations of region 234, approaching a near zero confidence value in region 236 of the key point heat map 124B. By applying the soft argmax function to the key point heat map 124B, the key point heat map estimation evaluation 126 may compute a predicted facial feature key point location 132 for this key point at heat map pixel coordinates x₂, y₂ that correspond to a peak confidence location. The predicted heat map pixel coordinates x₂, y₂ may be mapped to pixel coordinates of the facial image input to determine the facial feature key point location 132 within the facial image. With respect to the facial feature key point occlusion score 134, this value may be computed based on x-axis and y-axis distribution curves of confidence values of the key point heat map 124B, as illustrated at 240 and 244. As shown at 242, the x-axis distribution curve 241 comprises a domed peak at x=x₂, and a broad spread (distribution) 243 that may be characterized as the standard deviation, σₓ, of the x-axis distribution curve 241. As shown at 246, the y-axis distribution curve 245 comprises a well-defined peak at y=y₂, and a fairly narrow spread (distribution) 247 that may be characterized as the standard deviation, σ_{y}, of the y-axis distribution curve 245. A predicted facial feature key point occlusion score 134, based on key point heat map 124B, may then be computed as: occlusion score=f(σₓ, σ_{y}) (e.g., occlusionscore=\sqrt{σₓ²+σ_{y}²}, or other statistical metric). Further, the facial feature key point estimation model 120 may use key point occlusion classification prediction 128 to infer an occlusion classification 136 based at least on the facial image data 107 and/or the facial feature key point occlusion score 134 (e.g., an object-occluded and/or self-occluded key point classification for this particular example).

As another example, FIG. 2C is a diagram illustrating an example key point heat map 124C corresponding to a data channel of a key point heat map 124 for a facial feature key point that may be more substantially occluded than the key points of heat maps 124A and 124B. Here, the pixels of the heat map 124C within region 250 have pixel values representing the highest confidence values corresponding to a location that the facial feature key point estimation model 120 predicts most confidently as corresponding to the location of this facial feature key point. In this example, the area of region 250 comprises lower confidence values spread over a larger region than that of region 230 of heat map 124B, indicating that the facial feature key point estimation model 120 is less confident about a precise location of this facial feature key point. The confidence values of pixels decrease in neighboring region 252 and further decrease approaching a near zero confidence value in region 254 of the key point heat map 124C. By applying the soft argmax function to the key point heat map 124C, the key point heat map estimation evaluation 126 may compute a predicted facial feature key point location 132 for this key point at heat map pixel coordinates x₃, y₃ that correspond to a peak confidence location. The predicted heat map pixel coordinates x₃, y₃ may be mapped to pixel coordinates of the facial image input to determine the facial feature key point location 132 within the facial image. In this example, the heat map 124C indicates that the facial feature key point estimation model 120 may have a high degree of uncertainty about the position of this facial feature key point, and may be relying on its training of where this facial feature key point should be over data extractable from the facial image data 107. With respect to the facial feature key point occlusion score 134, this value may be computed based on x-axis and y-axis distribution curves of confidence values of the key point heat map 124C, as illustrated at 260 and 264. As shown at 262, the x-axis distribution curve 261 comprises a domed peak at x=x₃, and a broad spread (distribution) 263 that may be characterized as the standard deviation, σₓ, of the x-axis distribution curve 261. As shown at 266, the y-axis distribution curve 265 comprises a well-defined peak at y=y₃, and a fairly narrow spread (distribution) 267 that may be characterized as the standard deviation, σ_{y}, of the y-axis distribution curve 265. A predicted facial feature key point occlusion score 134, based on key point heat map 124C may then be computed as: occlusion score=f(σₓ, σ_{y}) (e.g., occlusionscore=\sqrt{σₓ²+σ_{y}²}, or other statistical metric). Further, the facial feature key point estimation model 120 may use key point occlusion classification prediction 128 to infer an occlusion classification 136 based at least on the facial image data 107 and/or the facial feature key point occlusion score 134 (e.g., an object-occluded, self-occluded key point classification, and/or a truncated occlusion for this particular example).

Returning to FIG. 1, based at least in part on the facial feature key point prediction data 130 (e.g., facial feature key point location 132, facial feature key point occlusion score 134, and/or occlusion classification 136), an interior monitoring system 150 (which may implement one or more components of the OMS) may generate one or more output(s) 154. Output(s) 154 may be generated using one or more machine learning models and/or deep neural networks (DNNs) 152. As an example, the interior monitoring system 150 may use facial feature key point prediction data 130 (either alone or in combination with other data such as optical image data from optical image sensor(s) 106) to predict the presence, location, pose, and/or gaze direction of occupants within the space of a vehicle interior. Other systems of the vehicle 700 may determine one or more actions to take based on the predictions and/or may control other tasks or operations. For example, based on output(s) 154, an alarm or warning may be generated, door locks and/or windows may be operated, various functions may be turned on/off, data for a digital assistant, chat bot, digital avatar, and/or the like may be generated, and/or air conditioning or air circulation functions may be operated. The facial feature key point prediction data 130 and/or output(s) 154 may be used for drowsiness detection OMS functions, drowsiness user adaptation for drowsiness detection OMS functions, diagnostic functions such as detecting sensor blockages and/or mis-positioned OMS cameras, and/or other operations to control one or more aspects of vehicle 700. For example, in some embodiments, airbag deployments, driver monitoring systems, occupant recognition, human-machine interface (HMI) applications, and/or other vehicle functions may be controlled based at least on data derived from facial feature key point prediction data 130.

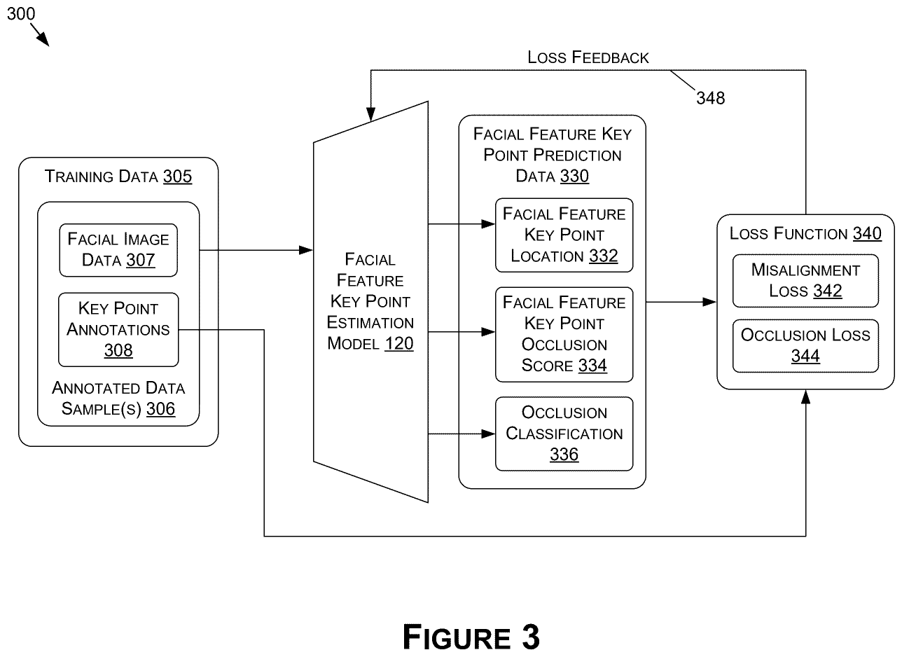

Referring now to FIG. 3, an example training architecture 300 is described for training a facial feature key point estimation model 120 in accordance with embodiments of this disclosure. In this example, a facial feature key point estimation model 120 may be trained to generate facial feature key point prediction data 130 based on an input of training data 305 comprising annotated data samples 306, with each annotated data sample 306 comprising facial image data 307 (e.g., images captured from one or more optical image sensors 106 and/or synthetic facial images), and ground truth (GT) facial feature key point annotations 308. The facial feature key point annotations 308 may include annotations labeling the locations of facial feature key points with respect to image frames of the facial image data 307. The facial feature key point annotations 308 may include annotations labeling the key points with occlusion classifications, (e.g., visible (not occluded), object-occluded, self-occluded, or a truncated occlusion). The training architecture 300 leverages these annotated data samples 306 to teach the facial feature key point estimation model 120 features that characterize distinct facial feature key points (left eye outer corner, left eye inner corner, left eye pupil center, right eye outer corner, right eye inner corner, right eye pupil center, left mouth corner, right mouth corner, and so forth) and relationships between facial feature key points and other features appearing in the facial image data 307, so that the facial feature key point estimation model 120 learns to infer data such as facial feature key point location 132, facial feature key point occlusion score 134, and/or occlusion classification 136, for various facial feature key points.

As shown in FIG. 3, the training architecture 300 comprises a loss function 340 to generate a loss feedback 348 used to iteratively update the facial feature key point estimation model 120 during training as the training data 305 is processed by the facial feature key point estimation model 120 to produce facial feature key point prediction data 330. The loss feedback 348 may be generated by the loss function 340 to optimize the key point predictions. During training, the facial feature key point estimation model 120 is fed an annotated data sample 306 to generate a key point heat map (e.g., a key point heat map 124) for a set of predefined facial feature key points. From the key point heat map for each facial feature key point, the facial feature key point estimation model 120 produces facial feature key point prediction data 330 comprising a facial feature key point location 332 (such as a facial feature key point location 132 described herein), a facial feature key point occlusion score 334 (such as a facial feature key point occlusion score 334 described herein), and/or an occlusion classification 336 (such as occlusion classification 136 described herein). The loss function 340 may compare the model-predicted location data 332 for each of the individual key points against the corresponding ground truth locations of those individual key points indicated by the key point annotations 308. The misalignment between the model-predicted location data 332 and ground truth annotated location data from the key point annotations 308 may be used by the loss function 340 to compute a misalignment loss 342 component of the loss feedback 348 that is applied to the facial feature key point estimation model 120 over iterations of annotated data samples 306 to optimize the key point location predictions. A second component of the loss feedback 348 computed by the loss function 340 may include an occlusion loss 344 (e.g., a key point occlusion loss). In some embodiments, the occlusion loss 344 may be computed based on the model's predicted occlusion score 334 and/or occlusion classification 336, and their deviation from one or more annotated occlusion labels from the key point annotations 308. The facial feature key point estimation model 120 is iteratively trained (e.g., thousands of iterations) on the annotated data samples 306 and adjusted over the iterations to drive the loss feedback 348 towards a minimum. In minimizing the misalignment and occlusion losses, the facial feature key point estimation model 120 is driven to produce facial feature key point heat maps with confidence value distributions that are more distinctively narrower or wider depending on the model's confidence in key point location predictions. As discussed herein, for observable non-occluded facial feature key points, the facial feature key point estimation model 120 should produce heat maps having narrow distributions since the model should be able to be confident in discerning a precise location of where a key point is located, and similarly confident in where it is not located. Conversely, for occluded facial feature key points, the facial feature key point estimation model 120 should produce heat maps having flatter and wider distributions since the model has less confidence in discerning a precise location of where a key point is located or not located.

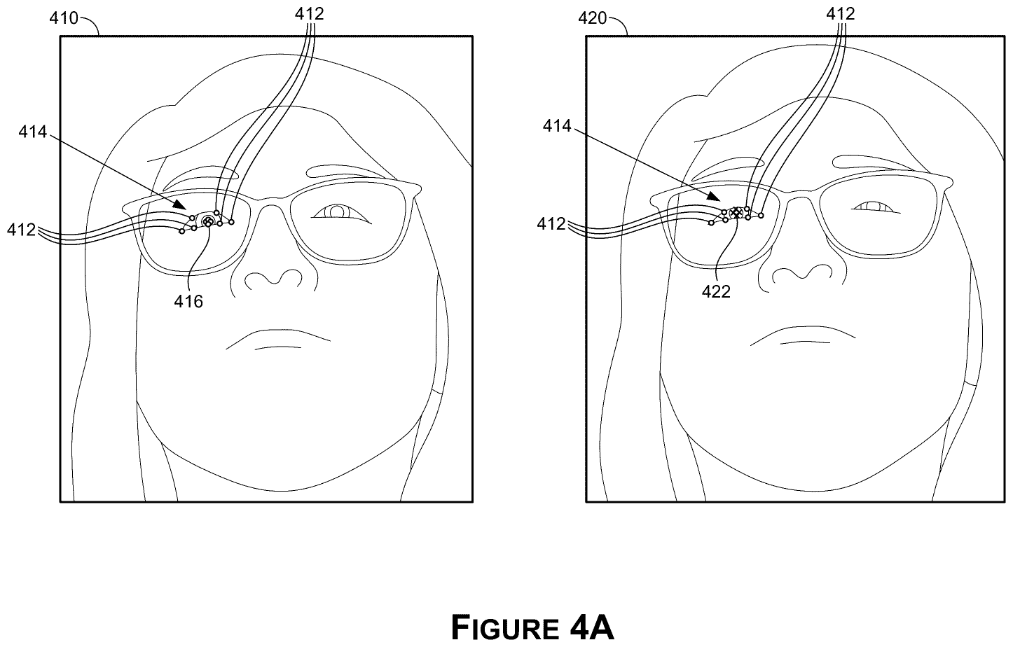

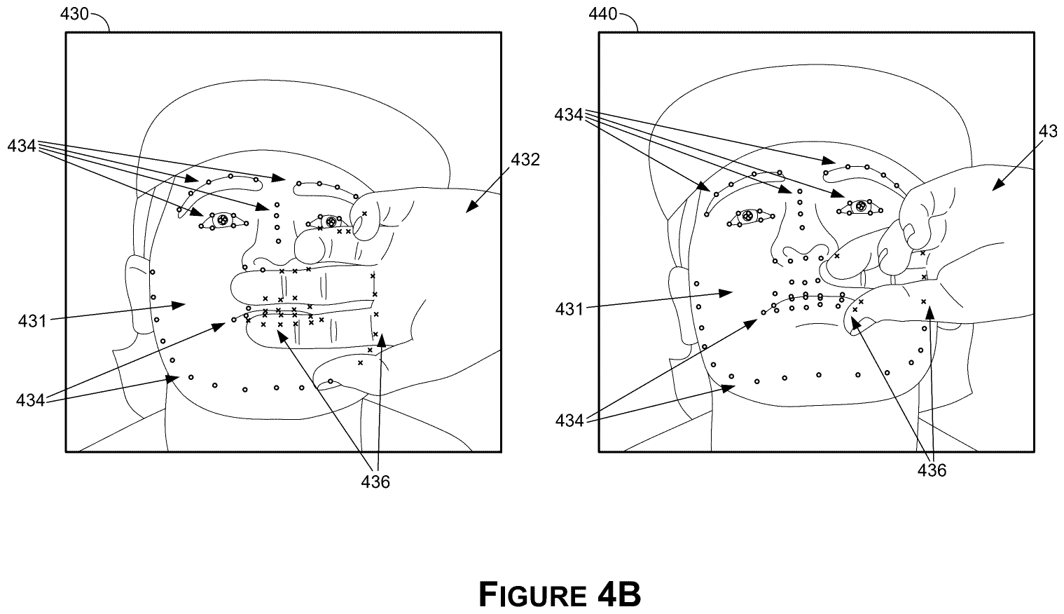

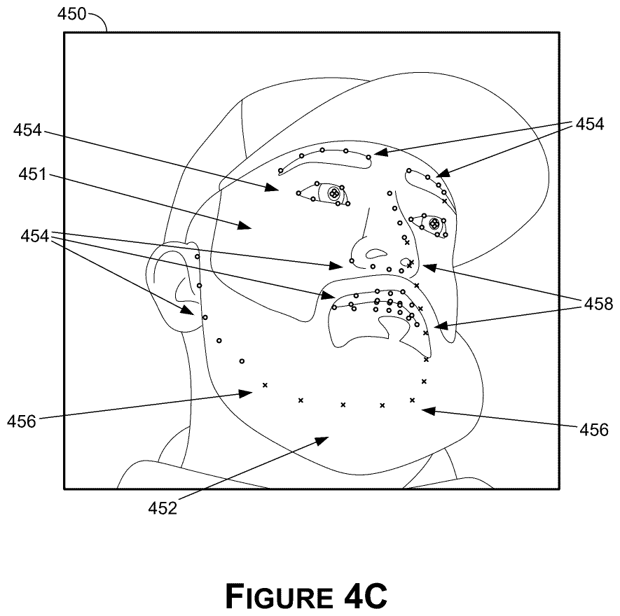

FIGS. 4A, 4B, and 4C are diagrams illustrating examples of facial feature key point location data and/or occlusion classifications predicted by a facial feature key point estimation model 120 according to some embodiments. In particular, FIGS. 4A, 4B, and 4C illustrate example frames of facial image data 107 overlaid with occlusion detection data at multiple facial feature key point locations predicted by the facial feature key point estimation model 120.

For example, in FIG. 4A, example frames 410 and 420 of facial image data each include a plurality of key point location predictions 412 corresponding to key points around an outline of the occupant's right eye socket 414. Although the occupant is wearing glasses, the facial feature key point estimation model 120 still has an unobstructed view of these key points around an outline of the occupant's right eye socket 414 so that the facial feature key point estimation model 120 may still infer key point heat map(s) 124 to generate these key point locations and infer a visible (non-obstructed) occlusion classification to these key point location predictions 412 (shown as “o”). In frame 410, the occupant's eye is open and the facial feature key point estimation model 120 has predicted a key point location prediction 416 corresponding to the occupant's right eye pupil. Again, although the occupant is wearing glasses, the facial feature key point estimation model 120 still has an unobstructed view of the occupant's right eye pupil so that the facial feature key point estimation model 120 infers a visible (non-obstructed) occlusion classification to the key point location predictions 416. In contrast, in frame 420, the occupant's eye is closed. As shown in FIG. 4A, the facial feature key point estimation model 120 may still infer key point heat map(s) 124 to generate a key point location prediction 422 (shown as “x”) corresponding to the occupant's occluded right eye pupil. However, the facial feature key point estimation model 120 does not have an unobstructed view of the occupant's right eye pupil and accordingly infers an occlusion classification (e.g., a self-occlusion and/or object occlusion) indicating that this key point is obstructed from view.

In example FIG. 4B, example frames 430 and 440 of facial image data each include a plurality of key point location predictions corresponding to key points around an outline of the occupant's jawline, eyebrows, eyes, mouth, and nose. In these examples, the occupant's face 431 is partially occluded due to the placement of the occupant's hand 432. The facial feature key point estimation model 120 still has an unobstructed view of the key points not obstructed by the hand 432, and may infer key point heat map(s) 124 to generate key point location predictions 434 (shown as “o”) corresponding to those key points, and infers an visible (non-obstructed) occlusion classification to these key point location predictions 434. However, the facial feature key point estimation model 120 does not have an unobstructed view of key points that are blocked from the sensor's view by the occupant's hand 432. The facial feature key point estimation model 120 may still infer key point heat map(s) 124 to generate key point location predictions 436 (shown as “x”) corresponding to the occluded key points and infer an occlusion classification (e.g., a self-occlusion and/or object occlusion) indicating that this key point is obstructed from view.

In example FIG. 4C, example frame 450 of facial image data includes a plurality of key point location predictions corresponding to key points around an outline of the occupant's jawline, eyebrows, eyes, mouth, and nose. In this example, the occupant's face 451 is partially occluded due to facial hair 452 and self-occlusion due to the occupant head pose that blocks one or more key points from the image sensor's view. The frame 450 provides an unobstructed view of the key points that are not obstructed so that the facial feature key point estimation model 120 may infer key point heat map(s) 124 to generate key point location predictions 454 (shown as “o”) corresponding to those non-occluded key points, with a visible (non-obstructed) occlusion classification for these key point location predictions 454. The frame 450 does not provide an unobstructed view of key points that are blocked from the sensor's view by the occupant's facial hair 452. The facial feature key point estimation model 120 may still infer key point heat map(s) 124 to generate key point location prediction 456 (shown as “x”) corresponding to the key points occluded by facial hair 452 and infer an occlusion classification (e.g., object occlusion) indicating that this key point is obstructed from view. The frame 450 also does not provide an unobstructed view of self-occluded key points 458 that are blocked from the sensors because of the occupant's head pose. As discussed above, the facial feature key point estimation model 120 may infer key point heat map(s) 124 to generate key point location prediction 436 corresponding to the self-occluded key points 458 (shown as “x”) and infer an occlusion classification (e.g., self-occlusion) indicating that these key points 458 are obstructed from view.

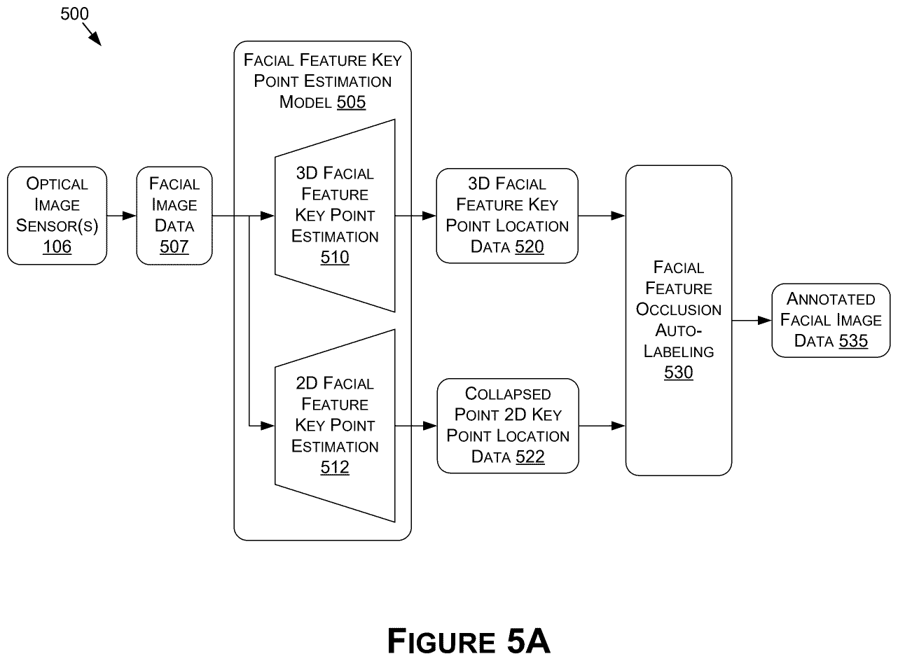

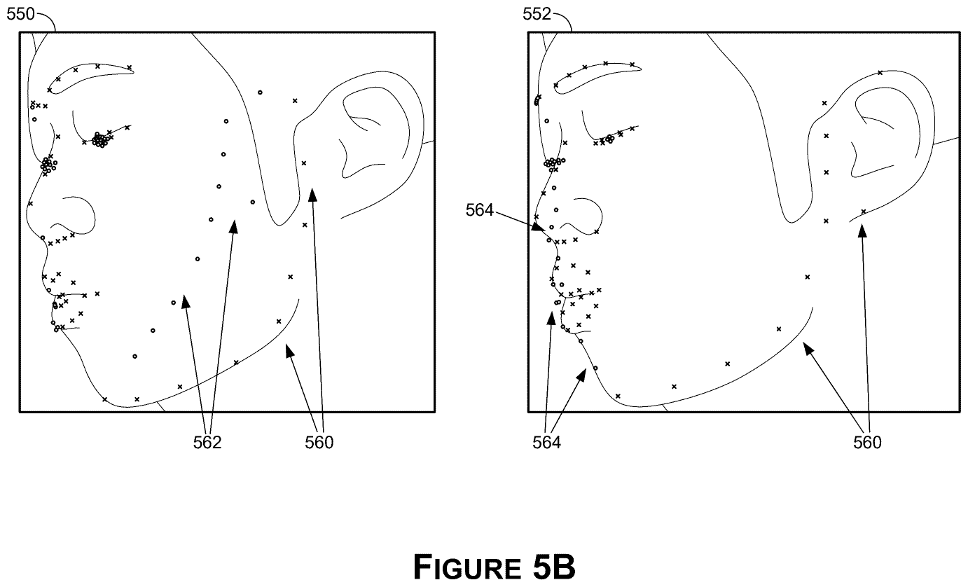

FIGS. 5A and 5B are diagrams illustrating an example facial image auto-labeling process 500 (e.g., for developing machine learning model training data) using a facial feature key point estimation model 505 according to embodiments, as described herein. In some embodiments, the systems, methods, and processes described herein with respect to facial image auto-labeling process may be executed using similar components, features, and/or functionalities to those of example autonomous vehicle 700 of FIGS. 7A-7D, example computing device 800 of FIG. 8, and/or example data center 900 of FIG. 9.

In this example, the facial feature key point estimation model 505 may be applied to a method to classify and label self-occluded facial feature key points from facial image data 507. In some embodiments, facial image data 507 may comprise one or more image frames that capture the face of a person, such as but not limited to a vehicle occupant. The facial image data 507 may represent facial images that were cropped from larger images. In some embodiments, the facial image data 107 may comprise one or more image frames, as captured by one or more optical image sensors 106 (e.g., one or more occupant monitoring system (OMS) sensor(s) 701 such as described with respect to the vehicle 700).

The facial feature key point estimation model 505 may include an inference model that performs 3D facial feature key point estimation 510 and an inference model that perform 2D facial feature key point estimation 512. With respect to the 3D facial feature key point estimation 510, the model 505 may be trained using a ground truth dataset that comprises 2D projections of 3D key points for key points that are self-occluded. That is, the human annotator may make an educated guess as to the location of a self-occluded key point and label the image by assigning a 2D projected location to that key point indicating a location that is projected onto the opposing side of the face. With respect to the 2D facial feature key point estimation 512, the model 505 may be trained using a ground truth dataset that annotates using the “collapsed points” technique. That is, for 2D facial feature key point estimation 512, the model 505 does not learn to predict the location of self-occluded key points on the non-observable side of the face, but instead is trained to assign the self-occluded key point labels to locations along an edge of the image of the face. As such, because facial feature key point estimation model 505 is trained on training data that includes samples from both 2D and 3D datasets, performing the 3D facial feature key point estimation 510 may generate a first key point location set comprising 3D facial feature key point location data 520 (as further illustrated at 550 in FIG. 5B) and second key point location set comprising collapsed point 2D key point location data 522 (as further illustrated at 552 in FIG. 5B). As shown in FIG. 5B, in a frame 550 of 3D facial feature key point location data 520, the 3D facial feature key point estimation 510 annotates the location of non-occluded key points (such as shown at 560) at locations where those key points are predicted to be, and also annotates the location of self-occluded key points (such as shown at 562) based on 2D projections of predicted locations from the self-occluded side of the face to the visible side of the face. In contrast, in a frame 552 of collapsed point 2D key point location data 522, the 2D facial feature key point estimation 512 annotates the location of self-occluded key points (such as shown at 564) along an edge of the image of the subject's face. Accordingly, in some embodiments, the facial image auto-labeling process 500 may comprise facial feature occlusion auto-labeling 530 that generates annotated facial image data 535 based on a comparison 3D facial feature key point location data 520 and collapsed point 2D key point location data 522.

When a facial image from facial image data 507 is processed through facial feature key point estimation model 505 to produce 3D facial feature key point location data 520 and collapsed point 2D key point location data 522, the locations of predicted key point locations may be compared to identify key point locations that are in agreement between the two frames (e.g., that align), and key point locations that are not in agreement between the two frames (e.g., that do not align). For example, with respect to frames 550 and 552 in FIG. 2B, corresponding predicted key point locations 560 are aligned between the frames (e.g., within an alignment threshold) because in neither frame are these key point locations represented using a collapsed point. As such, predicted key point locations 560 may be annotated by the facial feature occlusion auto-labeling 530 as non-occluded key points. In contrast, predicted key point locations 562 in frame 550 are substantially offset and not aligned (e.g., in excess of an alignment threshold) with their counterpart predicted key point locations 564 in frame 552. The predicted key point locations 562 in frame 550 are annotated at estimated locations based on 2D projection, while their corresponding predicted key point locations 564 in frame 552 are annotated at the edge of the subject's face. Based on this offset, the facial feature occlusion auto-labeling 530 may output annotated facial image data 535 based on the predicted key point locations 560 and 562 in frame 550, where the predicted key point locations 560 are annotated as non-occluded, and the predicted key point locations 562 are annotated as occluded. In some embodiments, the facial feature key point estimation model 505 may further function as described with respect to the facial feature key point estimation model 120 described herein. The facial feature key point estimation model 505 may apply multiclass auto-labeling of facial feature key points, for example, where a key point classified and labeled as being a self-occluded key point is further classified and labeled as having an object occlusion based on the detection of an object located between the occupant and the OMS camera. For example, for predicted key point locations 562 that are annotated as occluded, the facial feature key point estimation model 505 may generate an auto-annotation applied to facial image data 507 (e.g., based on a heat map 124 and/or occlusion classification) indicating that the annotated location of a self-occluded key point 562 is also obscured due to an object occlusion.

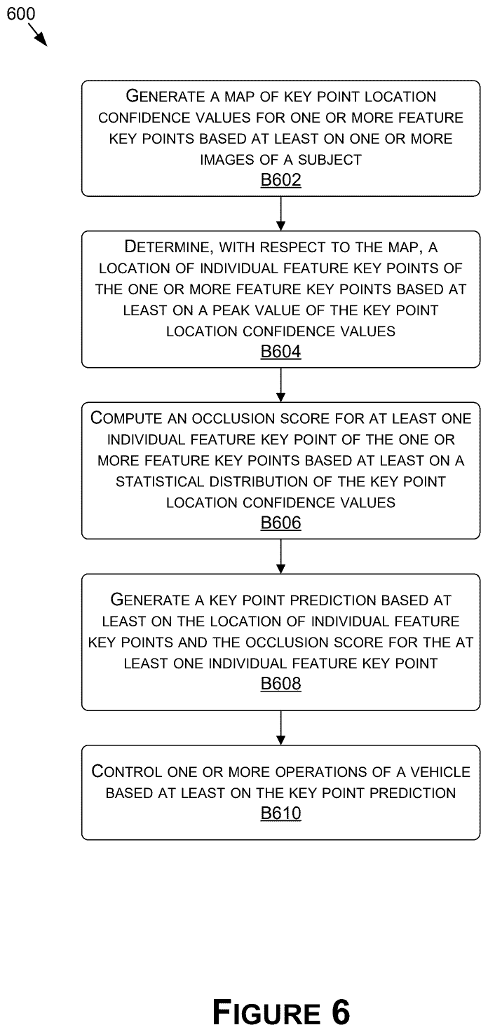

Now referring to FIG. 6, FIG. 6 is a flow diagram showing a method 600 for facial feature key point occlusion detection, in accordance with some embodiments of the present disclosure. The features and elements described herein with respect to the method 600 of FIG. 6 may be used in conjunction with, in combination with, or substituted for elements of any of the other embodiments discussed herein and vice versa. Further, the functions, structures, and other descriptions of elements for embodiments described in FIG. 6 may apply to like or similarly named or described elements across any of the figures and/or embodiments described herein and vice versa.

Each block of method 600, described herein, comprises a computing process that may be performed using any combination of hardware, firmware, and/or software. For instance, various functions may be carried out by one or more processors comprising processing circuitry and executing instructions stored in memory. The methods may additionally, or alternatively, be embodied as computer-usable instructions stored on computer storage media. The methods may be provided by a standalone application, a service or hosted service (standalone or in combination with another hosted service), or a plug-in to another product, to name a few. In addition, method 600 is described, by way of example, with respect to the facial feature key point prediction system 100 and/or facial feature key point estimation model 120 described in FIG. 1. However, these methods may additionally or alternatively be executed by any one system, or any combination of systems, including, but not limited to, those described herein.

In some embodiments, method 600 may generally be directed to generating key point prediction data representing one or more feature key points based at least on one or more facial images of a subject based at least on computing a peak value from a map of key point location confidence values inferred from the one or more facial images, and a statistical distribution based on a map of key point location confidence values.

The method 600, at block B602, includes generating a map of key point location confidence values for one or more feature key points based at least on one or more images of a subject. The one or more facial images of a subject may include facial image data 107, as discussed herein with respect to FIG. 1. The facial image data 107 may comprise one or more image frames that capture the face of a person, such as but not limited to a vehicle occupant. In some embodiments, the facial image data 107 may represent facial images that were cropped from larger images (e.g., cropped by a function of the facial feature key point prediction system 100 based on a bounding box that identifies the facial region of the person). In some embodiments, the facial image data 107 may comprise one or more image frames as captured by one or more optical image sensors 106. The optical image sensor(s) 106 may comprise, for example, one or more occupant monitoring system (OMS) sensor(s) 701 such as described with respect to the vehicle 700. In some embodiments, the facial image data 107 may be captured by an optical image sensor 106 comprising a camera, such as an RGB, IR, and/or RGB-IR camera. In some embodiments, facial image data 107 may comprise simultaneously captured image frames from multiple optical image sensors 106 that are stitched together to form a composite image frame for input to the facial feature key point detector 110. In some embodiments, the map of key point location confidence values may comprise one or more heat maps, such as key point heat map(s). 124. The facial feature key point estimation model 120 may comprise one or more layers that perform a key point heat map prediction 122 to generate the one or more key point heat maps. In some embodiments, the map comprises a heat map where pixels of the heat map represent one or more data channels, wherein individual data channels of the one or more data channels represent a respective key point location confidence value for a facial feature key point (e.g., left eye outer corner, left eye inner corner, left eye pupil center, right eye outer corner, right eye inner corner, right eye pupil center, left mouth corner, right mouth corner, and so forth). In some embodiments, the facial feature key point estimation model may infer an occlusion classification based at least on one of the one or more facial images and the map, wherein the occlusion classification indicates a type occlusion that is obscuring a facial feature key point of the one or more facial feature key points. The occlusion classification may comprise a classification such as 1) visible (not occluded), 2) object-occluded, 3) self-occluded, or 4) a truncated occlusion (occluded due to being outside the bounds of the facial image). The facial feature key point estimation model may be trained using facial image training data (such as illustrated in FIG. 3) wherein samples of the facial image training data comprise first annotations based on locations of the one or more facial feature key points and second annotations based on an indication of occlusion of the one or more facial feature key points. That is, a facial feature key point estimation model may be trained to generate facial feature key point prediction data based on an input of training data 305 comprising annotated data samples 306, with each annotated data sample 306 comprising facial image data 307 (e.g., images captured from one or more optical image sensors 106 and/or synthetic facial images), and ground truth (GT) facial feature key point annotations 308. The facial feature key point annotations 308 may include annotations labeling the locations of facial feature key points with respect to image frames of the facial image data 307. The facial feature key point annotations 308 may include annotations labeling the key points with occlusion classifications, (e.g., visible (not occluded), object-occluded, self-occluded, or a truncated occlusion). The facial feature key point estimation model may be trained based on optimizing the facial feature key point estimation model based at least on a key point location misalignment loss and an occlusion loss (e.g., a key point occlusion loss). In minimizing the misalignment and occlusion losses, the facial feature key point estimation model 120 is driven to produce facial feature key point heat maps with confidence value distributions that are more distinctively narrower or wider depending on the model's confidence in key point location predictions.

The method 600, at block B604, includes determining, with respect to the map, a location of individual feature key points of the one or more feature key points based at least on a peak value of the key point location confidence values. From the key point heat map for each facial feature key point, the method may determine the location (e.g., x, y coordinates) having a peak value to define the estimated location of a facial feature key point (e.g., using soft argmax), such as is illustrated and discussed with respect to FIGS. 2A, 2B, and 2C. By applying the soft argmax function to the key point heat map 124A, the facial feature key point estimation model 120 may compute a predicted facial feature key point location 132 at heat map pixel coordinates x₁, y₁ that correspond to a peak confidence location. The predicted heat map pixel coordinates x₁, y₁ may be mapped to pixel coordinates of the facial image input to determine the facial feature key point location 132 within the facial image.

The method 600, at block B606, includes computing an occlusion score for at least one individual feature key point of the one or more feature key points based at least on a statistical distribution of the key point location confidence values. A facial feature key point heat map may comprise a distribution (e.g., a 2D Gaussian distribution) where the peak probability of the Gaussian distribution provides the estimated location of the facial feature key point, and the standard deviation of the Gaussian distribution provides an indication of whether the facial feature key point that is occluded can be normalized to an occlusion score for that facial feature key point (e.g., as illustrated and discussed with respect to FIGS. 2A, 2B, and 2C). A predicted facial feature key point occlusion score, based on a key point heat map, may be computed as a function of x-axis standard deviation (σₓ) and y-axis standard deviation (σ_{y}), (e.g., occlusionscore=\sqrt{σₓ²+σ_{y}²}, or other statistical metric). Further, the facial feature key point estimation model may infer an occlusion classification based at least on the facial image data and/or the facial feature key point occlusion score.

The method 600, at block B608, includes generating a key point prediction based at least on the location of individual feature key points and the occlusion score for the at least one individual feature key point. The method may correlate the location of individual facial feature key points with respect to the map with one or more key point locations with respect to the one or more facial images of the subject to generate the key point prediction data output. That is, the predicted heat map pixel coordinates x₁, y₁ may be mapped to pixel coordinates of the facial image input to determine the facial feature key point location 132 within the facial image.

As discussed with respect to FIGS. 5A and 5B, in some embodiments, a heat map representing key point location confidence values is generated using a machine learning model trained based at least on a two-dimensional facial feature key point data set and a three-dimensional facial feature key point data set comprising one or more two-dimensional projections of self-occluded facial feature key points. That is, when a facial image from facial image data is processed through a facial feature key point estimation model to produce 3D facial feature key point location data and collapsed point 2D key point location data, the locations of predicted key point locations may be compared to identify key point locations that are in agreement between the two frames (e.g., that align), and key point locations that are not in agreement between the two frames (e.g., that do not align). Occluded key point locations may be determined (and labeled) based on identifying predicted key point locations in a first frame that are substantially offset and not aligned (e.g., in excess of an alignment threshold) with their counterpart predicted key point locations in the second frame. In some embodiments, the method may include applying one or more labels to auto-annotate one or more facial images of a subject based on one or more inferences from the one or more facial images that indicate that the at least one individual facial feature key point is a self-occluded key point with an object occlusion.

The method 600, at block B610, includes controlling one or more operations of a vehicle based at least on the key point prediction. For example, as discussed with respect to FIG. 1, based at least in part on the facial feature key point prediction data 130 (which may include facial feature key point location 132, facial feature key point occlusion score 134, and/or occlusion classification 136), an interior monitoring system 150 may generate one or more output(s) 154. Output(s) 154 may be generated using one or more machine learning models and/or deep neural networks (DNNs) 152. The interior monitoring system 150 may use facial feature key point prediction data (either alone or in combination with other data such as optical image data from optical image sensor(s) 106) to predict the presence, location, pose, and/or gaze direction of occupants within the space of a vehicle interior. Other systems of the vehicle 700 may determine one or more actions to take based on the predictions and/or may control other tasks or operations. For example, based on output(s) 154, an alarm or warning may be generated, door locks and/or windows may be operated, various functions may be turned on/off, data for a digital assistant, chat bot, digital avatar, and/or the like may be generated, and/or air conditioning or air circulation functions may be operated. The facial feature key point prediction data 130 and/or output(s) 154 may be used for drowsiness detection OMS functions, drowsiness user adaptation for drowsiness detection OMS functions, diagnostic functions such as detecting sensor blockages and/or mis-positioned OMS cameras, and/or other operations to control one or more aspects of vehicle 700. For example, in some embodiments, airbag deployments, driver monitoring systems, occupant recognition, HMI applications, and/or other vehicle functions may be controlled based at least on data derived from facial feature key point prediction data 130.

In some embodiments, the systems and methods described herein may be performed within, or in conjunction with, a simulation environment (e.g., NVIDIA's DriveSIM) using simulated data (e.g., simulated sensor data of simulated sensors of a virtual or simulated machine). For example, simulated sensor data may be used that includes the application of realistic facial feature key point prediction data generated from within the simulation environment, and the simulation may use facial feature key point prediction data to perform operations (e.g., navigating, vehicle safety features, etc.) associated with the virtual machine within the environment. These simulated operations may be used to test performance of the underlying algorithms, systems, and/or processes prior to deploying them in the real world. In some instances, the simulation may be used to generate synthetic training data—e.g., training data including regions of interest and/or subregions of interest from within the simulation. The synthetic training data (in addition to or alternatively from real-world data) may then be processed for various OMS operations, such as to determine gaze direction and/or drowsiness of a driver and/or other occupant, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. For example, the content collaboration platform or system may include a system for using or developing universal scene descriptor (USD) (e.g., OpenUSD) data for managing objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs) and/or one or more vision language models (VLMs), systems for performing light transport simulation, systems for performing collaborative content creation for 3D assets, systems implemented at least partially using cloud computing resources, and/or other types of systems.

### Example Autonomous Vehicle

FIG. 7A is an illustration of an example autonomous vehicle 700, in accordance with some embodiments of the present disclosure. The autonomous vehicle 700 (alternatively referred to herein as the “vehicle 700”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 700 may be capable of functionality in accordance with one or more of Level 3-Level 5 of the autonomous driving levels. The vehicle 700 may be capable of functionality in accordance with one or more of Level 1-Level 5 of the autonomous driving levels. For example, the vehicle 700 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 700 or other machine, such as being fully autonomous, being highly autonomous, being conditionally autonomous, being partially autonomous, providing assistive autonomy, being semi-autonomous, being primarily autonomous, or other designation.

The vehicle 700 may include components such as a chassis, a vehicle body, wheels (e.g., 2, 4, 6, 8, 18, etc.), tires, axles, and other components of a vehicle. The vehicle 700 may include a propulsion system 750, such as an internal combustion engine, hybrid electric power plant, an all-electric engine, and/or another propulsion system type. The propulsion system 750 may be connected to a drive train of the vehicle 700, which may include a transmission, to allow the propulsion of the vehicle 700. The propulsion system 750 may be controlled in response to receiving signals from the throttle/accelerator 752.

A steering system 754, which may include a steering wheel, may be used to steer the vehicle 700 (e.g., along a desired path or route) when the propulsion system 750 is operating (e.g., when the vehicle is in motion). The steering system 754 may receive signals from a steering actuator 756. The steering wheel may be optional for full automation (Level 5) functionality.

The brake sensor system 746 may be used to operate the vehicle brakes in response to receiving signals from the brake actuators 748 and/or brake sensors.

Controller(s) 736, which may include one or more system on chips (SoCs) 704 (e.g., 704(A) and 704(B) in FIG. 7C) and/or GPU(s), may provide signals (e.g., representative of commands) to one or more components and/or systems of the vehicle 700. For example, the controller(s) may send signals to operate the vehicle brakes via one or more brake actuators 748, to operate the steering system 754 via one or more steering actuators 756, to operate the propulsion system 750 via one or more throttle/accelerators 752. The controller(s) 736 may include one or more onboard (e.g., integrated) computing devices (e.g., supercomputers) that process sensor signals, and output operation commands (e.g., signals representing commands) to allow autonomous driving and/or to assist a human driver in driving the vehicle 700. The controller(s) 736 may include a first controller 736 for autonomous driving functions, a second controller 736 for functional safety functions, a third controller 736 for artificial intelligence functionality (e.g., computer vision), a fourth controller 736 for infotainment functionality, a fifth controller 736 for redundancy in emergency conditions, and/or other controllers. In some examples, a single controller 736 may handle two or more of the above functionalities, two or more controllers 736 may handle a single functionality, and/or any combination thereof.

The controller(s) 736 may provide the signals for controlling one or more components and/or systems of the vehicle 700 in response to sensor data received from one or more sensors (e.g., sensor inputs). The sensor data, such as but not limited to facial image data 107, may be received from, for example and without limitation, global navigation satellite systems (“GNSS”) sensor(s) 758 (e.g., Global Positioning System sensor(s)), RADAR sensor(s) 760, ultrasonic sensor(s) 762, LiDAR sensor(s) 764, inertial measurement unit (IMU) sensor(s) 766 (e.g., accelerometer(s), gyroscope(s), magnetic compass(es), magnetometer(s), etc.), microphone(s) 796, stereo camera(s) 768, wide-view camera(s) 770 (e.g., fisheye cameras), infrared camera(s) 772, surround camera(s) 774 (e.g., 360 degree cameras), long-range and/or mid-range camera(s) 798, speed sensor(s) 744 (e.g., for measuring the speed of the vehicle 700), vibration sensor(s) 742, steering sensor(s) 740, brake sensor(s) (e.g., as part of the brake sensor system 746), one or more occupant monitoring system (OMS) sensor(s) 701 (e.g., one or more interior cameras), and/or other sensor types. The controller(s) 736 may provide the signals for controlling one or more components and/or systems of the vehicle 700 in response to facial feature key point prediction data 130 generated by a facial feature key point estimation model 120 as described herein.

One or more of the controller(s) 736 may receive inputs (e.g., represented by input data) from an instrument cluster 732 of the vehicle 700 and provide outputs (e.g., represented by output data, display data, etc.) via a human-machine interface (HMI) display 734, an audible annunciator, a loudspeaker, and/or via other components of the vehicle 700. The outputs may include information such as vehicle velocity, speed, time, map data (e.g., the High Definition (“HD”) map 722 of FIG. 7C), location data (e.g., the vehicle's 700 location, such as on a map), direction, location of other vehicles (e.g., an occupancy grid), information about objects and status of objects as perceived by the controller(s) 736, etc. For example, the HMI display 734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 700 further includes a network interface 724 which may use one or more wireless antenna(s) 726 and/or modem(s) to communicate over one or more networks. For example, the network interface 724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 726 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 7B is an example of camera locations and fields of view for the example autonomous vehicle 700 of FIG. 7A, in accordance with some embodiments of the present disclosure. The cameras and respective fields of view are one example embodiment and are not intended to be limiting. For example, additional and/or alternative cameras may be included and/or the cameras may be located at different locations on the vehicle 700.

The camera types for the cameras may include, but are not limited to, digital cameras that may be adapted for use with the components and/or systems of the vehicle 700. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity. In some embodiments, optical image sensor(s) 106 may comprises one or more of the sensors and/or cameras described with respect to FIGS. 7A and 7B.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 700 (e.g., front-facing cameras) may be used for surround view, to help identify forward facing paths and obstacles, as well aid in, with the help of one or more controllers 736 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 770 that may be used to perceive objects coming into view from the periphery (e.g., pedestrians, crossing traffic or bicycles). Although only one wide-view camera is illustrated in FIG. 7B, there may be any number (including zero) of wide-view cameras 770 on the vehicle 700. In addition, any number of long-range camera(s) 798 (e.g., a long-view stereo camera pair) may be used for depth-based object detection, especially for objects for which a neural network has not yet been trained. The long-range camera(s) 798 may also be used for object detection and classification, as well as basic object tracking.

Any number of stereo cameras 768 may also be included in a front-facing configuration. In at least one embodiment, one or more of stereo camera(s) 768 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 768 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 768 may be used in addition to, or alternatively from, those described herein.

Cameras with a field of view that include portions of the environment to the side of the vehicle 700 (e.g., side-view cameras) may be used for surround view, providing information used to create and update the occupancy grid, as well as to generate side impact collision warnings. For example, surround camera(s) 774 (e.g., four surround cameras 774 as illustrated in FIG. 7B) may be positioned to on the vehicle 700. The surround camera(s) 774 may include wide-view camera(s) 770, fisheye camera(s), 360 degree camera(s), and/or the like. Four example, four fisheye cameras may be positioned on the vehicle's front, rear, and sides. In an alternative arrangement, the vehicle may use three surround camera(s) 774 (e.g., left, right, and rear), and may leverage one or more other camera(s) (e.g., a forward-facing camera) as a fourth surround view camera.

Cameras with a field of view that include portions of the environment to the rear of the vehicle 700 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 798, stereo camera(s) 768), infrared camera(s) 772, etc.), as described herein.

Cameras with a field of view that include portions of the interior environment within the cabin of the vehicle 700 (e.g., one or more OMS sensor(s) 701) may be used as part of an occupant monitoring system (OMS) such as, but not limited to, a driver monitoring system (DMS). For example, OMS sensors (e.g., the OMS sensor(s) 701) may be used (e.g., by the controller(s) 736) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle). In some embodiments, the OMS may track an occupant's and/or driver's gaze direction, head pose, and/or blinking, or perform other functions, based on facial feature key point prediction data 130.

FIG. 7C is a block diagram of an example system architecture for the example autonomous vehicle 700 of FIG. 7A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 700 in FIG. 7C are illustrated as being connected via bus 702. The bus 702 may include a Controller Area Network (CAN) data interface (alternatively referred to herein as a “CAN bus”). A CAN may be a network inside the vehicle 700 used to aid in control of various features and functionality of the vehicle 700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 702 is described herein as being a CAN bus, this is not intended to be limiting. For example, in addition to, or alternatively from, the CAN bus, FlexRay and/or Ethernet may be used. Additionally, although a single line is used to represent the bus 702, this is not intended to be limiting. For example, there may be any number of busses 702, which may include one or more CAN busses, one or more FlexRay busses, one or more Ethernet busses, and/or one or more other types of busses using a different protocol. In some examples, two or more busses 702 may be used to perform different functions, and/or may be used for redundancy. For example, a first bus 702 may be used for collision avoidance functionality and a second bus 702 may be used for actuation control. In any example, each bus 702 may communicate with any of the components of the vehicle 700, and two or more busses 702 may communicate with the same components. In some examples, each SoC 704, each controller 736, and/or each computer within the vehicle may have access to the same input data (e.g., inputs from sensors of the vehicle 700), and may be connected to a common bus, such the CAN bus.

The vehicle 700 may include one or more controller(s) 736, such as those described herein with respect to FIG. 7A. The controller(s) 736 may be used for a variety of functions. The controller(s) 736 may be coupled to any of the various other components and systems of the vehicle 700, and may be used for control of the vehicle 700, artificial intelligence of the vehicle 700, infotainment for the vehicle 700, and/or the like.

The vehicle 700 may include a system(s) on a chip (SoC) 704. The SoC 704 may include CPU(s) 706, GPU(s) 708, processor(s) 710, cache(s) 712, accelerator(s) 714, data store(s) 716, and/or other components and features not illustrated. The SoC(s) 704 may be used to control the vehicle 700 in a variety of platforms and systems. For example, the SoC(s) 704 may be combined in a system (e.g., the system of the vehicle 700) with an HD map 722 which may obtain map refreshes and/or updates via a network interface 724 from one or more servers (e.g., server(s) 778 of FIG. 7D).

The CPU(s) 706 may include a CPU cluster or CPU complex (alternatively referred to herein as a “CCPLEX”). The CPU(s) 706 may include multiple cores and/or L2 caches. For example, in some embodiments, the CPU(s) 706 may include eight cores in a coherent multi-processor configuration. In some embodiments, the CPU(s) 706 may include four dual-core clusters where each cluster has a dedicated L2 cache (e.g., a 2 MB L2 cache). The CPU(s) 706 (e.g., the CCPLEX) may be configured to support simultaneous cluster operation allowing any combination of the clusters of the CPU(s) 706 to be active at any given time.

The CPU(s) 706 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 706 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 708 may include an integrated GPU (alternatively referred to herein as an “iGPU”). The GPU(s) 708 may be programmable and may be efficient for parallel workloads. The GPU(s) 708, in some examples, may use an enhanced tensor instruction set. The GPU(s) 708 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 708 may include at least eight streaming microprocessors. The GPU(s) 708 may use compute application programming interface(s) (API(s)). In addition, the GPU(s) 708 may use one or more parallel computing platforms and/or programming models (e.g., NVIDIA's CUDA).

The GPU(s) 708 may be power-optimized for best performance in automotive and embedded use cases. For example, the GPU(s) 708 may be fabricated on a Fin field-effect transistor (FinFET). However, this is not intended to be limiting and the GPU(s) 708 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 708 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 708 to access the CPU(s) 706 page tables directly. In such examples, when the GPU(s) 708 memory management unit (MMU) experiences a miss, an address translation request may be transmitted to the CPU(s) 706. In response, the CPU(s) 706 may look in its page tables for the virtual-to-physical mapping for the address and transmits the translation back to the GPU(s) 708. As such, unified memory technology may allow a single unified virtual address space for memory of both the CPU(s) 706 and the GPU(s) 708, thereby simplifying the GPU(s) 708 programming and porting of applications to the GPU(s) 708.

In addition, the GPU(s) 708 may include an access counter that may keep track of the frequency of access of the GPU(s) 708 to memory of other processors. The access counter may help ensure that memory pages are moved to the physical memory of the processor that is accessing the pages most frequently.

The SoC(s) 704 may include any number of cache(s) 712, including those described herein. For example, the cache(s) 712 may include an L3 cache that is available to both the CPU(s) 706 and the GPU(s) 708 (e.g., that is connected both the CPU(s) 706 and the GPU(s) 708). The cache(s) 712 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 704 may include an arithmetic logic unit(s) (ALU(s)) which may be leveraged in performing processing with respect to any of the variety of tasks or operations of the vehicle 700—such as processing DNNs. In addition, the SoC(s) 704 may include a floating point unit(s) (FPU(s))—or other math coprocessor or numeric coprocessor types—for performing mathematical operations within the system. For example, the SoC(s) 704 may include one or more FPUs integrated as execution units within a CPU(s) 706 and/or GPU(s) 708. In some embodiments, one or more functions of the facial feature key point estimation model 120 may be performed at least in part using CPU(s) 706, GPU(s) 708 and/or SoC(s) 704.

The SoC(s) 704 may include one or more accelerators 714 (e.g., hardware accelerators, software accelerators, or a combination thereof). For example, the SoC(s) 704 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 708 and to off-load some of the tasks of the GPU(s) 708 (e.g., to free up more cycles of the GPU(s) 708 for performing other tasks). As an example, the accelerator(s) 714 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 714 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 708, and by using an inference accelerator, for example, a designer may target either the DLA(s) or the GPU(s) 708 for any function. For example, the designer may focus processing of CNNs and floating point operations on the DLA(s) and leave other functions to the GPU(s) 708 and/or other accelerator(s) 714.

The accelerator(s) 714 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 706. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 714 (e.g., the hardware acceleration cluster) may include a computer vision network on-chip and SRAM, for providing a high-bandwidth, low latency SRAM for the accelerator(s) 714. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 704 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 714 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 766 output that correlates with the vehicle 700 orientation, distance, 3D location estimates of the object obtained from the neural network and/or other sensors (e.g., LiDAR sensor(s) 764 or RADAR sensor(s) 760), among others.

The SoC(s) 704 may include data store(s) 716 (e.g., memory). The data store(s) 716 may be on-chip memory of the SoC(s) 704, which may store neural networks to be executed on the GPU and/or the DLA. In some examples, the data store(s) 716 may be large enough in capacity to store multiple instances of neural networks for redundancy and safety. The data store(s) 716 may comprise L2 or L3 cache(s) 712. Reference to the data store(s) 716 may include reference to the memory associated with the PVA, DLA, and/or other accelerator(s) 714, as described herein.

The SoC(s) 704 may include one or more processor(s) 710 (e.g., embedded processors). The processor(s) 710 may include a boot and power management processor that may be a dedicated processor and subsystem to handle boot power and management functions and related security enforcement. The boot and power management processor may be a part of the SoC(s) 704 boot sequence and may provide runtime power management services. The boot power and management processor may provide clock and voltage programming, assistance in system low power state transitions, management of SoC(s) 704 thermals and temperature sensors, and/or management of the SoC(s) 704 power states. Each temperature sensor may be implemented as a ring-oscillator whose output frequency is proportional to temperature, and the SoC(s) 704 may use the ring-oscillators to detect temperatures of the CPU(s) 706, GPU(s) 708, and/or accelerator(s) 714. If temperatures are determined to exceed a threshold, the boot and power management processor may enter a temperature fault routine and put the SoC(s) 704 into a lower power state and/or put the vehicle 700 into a chauffeur to safe stop mode (e.g., bring the vehicle 700 to a safe stop).

The processor(s) 710 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 710 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 710 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 710 may further include a real-time camera engine that may include a dedicated processor subsystem for handling real-time camera management.

The processor(s) 710 may further include a high-dynamic range signal processor that may include an image signal processor that is a hardware engine that is part of the camera processing pipeline.

The processor(s) 710 may include a video image compositor that may be a processing block (e.g., implemented on a microprocessor) that implements video post-processing functions needed by a video playback application to produce the final image for the player window. The video image compositor may perform lens distortion correction on wide-view camera(s) 770, surround camera(s) 774, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 708 is not required to continuously render new surfaces. Even when the GPU(s) 708 is powered on and active doing 3D rendering, the video image compositor may be used to offload the GPU(s) 708 to improve performance and responsiveness.

The SoC(s) 704 may further include a mobile industry processor interface (MIPI) camera serial interface for receiving video and input from cameras, a high-speed interface, and/or a video input block that may be used for camera and related pixel input functions. The SoC(s) 704 may further include an input/output controller(s) that may be controlled by software and may be used for receiving I/O signals that are uncommitted to a specific role.

The SoC(s) 704 may further include a broad range of peripheral interfaces to allow communication with peripherals, audio codecs, power management, and/or other devices. The SoC(s) 704 may be used to process data from cameras (e.g., connected over Gigabit Multimedia Serial Link and Ethernet), sensors (e.g., LiDAR sensor(s) 764, RADAR sensor(s) 760, etc. that may be connected over Ethernet), data from bus 702 (e.g., speed of vehicle 700, steering wheel position, etc.), data from GNSS sensor(s) 758 (e.g., connected over Ethernet or CAN bus). The SoC(s) 704 may further include dedicated high-performance mass storage controllers that may include their own DMA engines, and that may be used to free the CPU(s) 706 from routine data management tasks.

The SoC(s) 704 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 704 may be faster, more reliable, and even more energy-efficient and space-efficient than conventional systems. For example, the accelerator(s) 714, when combined with the CPU(s) 706, the GPU(s) 708, and the data store(s) 716, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 720) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 708.

In some examples, a CNN for facial recognition and vehicle owner identification may use data from camera sensors to identify the presence of an authorized driver and/or owner of the vehicle 700. The always on sensor processing engine may be used to unlock the vehicle when the owner approaches the driver door and turn on the lights, and, in security mode, to disable the vehicle when the owner leaves the vehicle. In this way, the SoC(s) 704 provide for security against theft and/or carjacking.

In another example, a CNN for emergency vehicle detection and identification may use data from microphones 796 to detect and identify emergency vehicle sirens. In contrast to conventional systems, that use general classifiers to detect sirens and manually extract features, the SoC(s) 704 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 758. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 762, until the emergency vehicle(s) passes.

The vehicle may include a CPU(s) 718 (e.g., discrete CPU(s), or dCPU(s)), that may be coupled to the SoC(s) 704 via a high-speed interconnect (e.g., PCIe). The CPU(s) 718 may include an X86 processor, for example. The CPU(s) 718 may be used to perform any of a variety of functions, including arbitrating potentially inconsistent results between ADAS sensors and the SoC(s) 704, and/or monitoring the status and health of the controller(s) 736 and/or infotainment SoC 730, for example.

The vehicle 700 may include a GPU(s) 720 (e.g., discrete GPU(s), or dGPU(s)), that may be coupled to the SoC(s) 704 via a high-speed interconnect (e.g., NVIDIA's NVLINK). The GPU(s) 720 may provide additional artificial intelligence functionality, such as by executing redundant and/or different neural networks, and may be used to train and/or update neural networks based on input (e.g., sensor data) from sensors of the vehicle 700.

The vehicle 700 may further include the network interface 724 which may include one or more wireless antennas 726 (e.g., one or more wireless antennas for different communication protocols, such as a cellular antenna, a Bluetooth antenna, etc.). The network interface 724 may be used to allow wireless connectivity over the Internet with the cloud (e.g., with the server(s) 778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 700 information about vehicles in proximity to the vehicle 700 (e.g., vehicles in front of, on the side of, and/or behind the vehicle 700). This functionality may be part of a cooperative adaptive cruise control functionality of the vehicle 700.

The network interface 724 may include a SoC that provides modulation and demodulation functionality and enables the controller(s) 736 to communicate over wireless networks. The network interface 724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 700 may further include data store(s) 728 which may include off-chip (e.g., off the SoC(s) 704) storage. The data store(s) 728 may include one or more storage elements including RAM, SRAM, DRAM, VRAM, Flash, hard disks, and/or other components and/or devices that may store at least one bit of data.

The vehicle 700 may further include GNSS sensor(s) 758. The GNSS sensor(s) 758 (e.g., GPS, assisted GPS sensors, differential GPS (DGPS) sensors, etc.), to assist in mapping, perception, occupancy grid generation, and/or path planning functions. Any number of GNSS sensor(s) 758 may be used, including, for example and without limitation, a GPS using a USB connector with an Ethernet to Serial (RS-232) bridge.

The vehicle 700 may further include RADAR sensor(s) 760. The RADAR sensor(s) 760 may be used by the vehicle 700 for long-range vehicle detection, even in darkness and/or severe weather conditions. RADAR functional safety levels may be ASIL B. The RADAR sensor(s) 760 may use the CAN and/or the bus 702 (e.g., to transmit data generated using the RADAR sensor(s) 760) for control and to access object tracking data, with access to Ethernet to access raw data in some examples. A wide variety of RADAR sensor types may be used. For example, and without limitation, the RADAR sensor(s) 760 may be suitable for front, rear, and side RADAR use. In some example, Pulse Doppler RADAR sensor(s) are used.

The RADAR sensor(s) 760 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 760 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 700 surroundings at higher speeds with minimal interference from traffic in adjacent lanes. The other two antennae may expand the field of view, making it possible to quickly detect vehicles entering or leaving the vehicle's 700 lane.

Mid-range RADAR systems may include, as an example, a range of up to 760 m (front) or 80 m (rear), and a field of view of up to 42 degrees (front) or 750 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 700 may further include ultrasonic sensor(s) 762. The ultrasonic sensor(s) 762, which may be positioned at the front, back, and/or the sides of the vehicle 700, may be used for park assist and/or to create and update an occupancy grid. A wide variety of ultrasonic sensor(s) 762 may be used, and different ultrasonic sensor(s) 762 may be used for different ranges of detection (e.g., 2.5 m, 4 m). The ultrasonic sensor(s) 762 may operate at functional safety levels of ASIL B.

The vehicle 700 may include LiDAR sensor(s) 764. The LiDAR sensor(s) 764 may be used for object and pedestrian detection, emergency braking, collision avoidance, and/or other functions. The LiDAR sensor(s) 764 may be functional safety level ASIL B. In some examples, the vehicle 700 may include multiple LiDAR sensors 764 (e.g., two, four, six, etc.) that may use Ethernet (e.g., to provide data to a Gigabit Ethernet switch).

In some examples, the LiDAR sensor(s) 764 may be capable of providing a list of objects and their distances for a 360-degree field of view. Commercially available LiDAR sensor(s) 764 may have an advertised range of approximately 700 m, with an accuracy of 2 cm-3 cm, and with support for a 700 Mbps Ethernet connection, for example. In some examples, one or more non-protruding LiDAR sensors 764 may be used. In such examples, the LiDAR sensor(s) 764 may be implemented as a small device that may be embedded into the front, rear, sides, and/or corners of the vehicle 700. The LiDAR sensor(s) 764, in such examples, may provide up to a 120-degree horizontal and 35-degree vertical field-of-view, with a 200 m range even for low-reflectivity objects. Front-mounted LiDAR sensor(s) 764 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 700. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 764 may be less susceptible to motion blur, vibration, and/or shock.

The vehicle may further include IMU sensor(s) 766. The IMU sensor(s) 766 may be located at a center of the rear axle of the vehicle 700, in some examples. The IMU sensor(s) 766 may include, for example and without limitation, an accelerometer(s), a magnetometer(s), a gyroscope(s), a magnetic compass(es), and/or other sensor types. In some examples, such as in six-axis applications, the IMU sensor(s) 766 may include accelerometers and gyroscopes, while in nine-axis applications, the IMU sensor(s) 766 may include accelerometers, gyroscopes, and magnetometers.

In some embodiments, the IMU sensor(s) 766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 766 may allow the vehicle 700 to estimate heading without requiring input from a magnetic sensor by directly observing and correlating the changes in velocity from GPS to the IMU sensor(s) 766. In some examples, the IMU sensor(s) 766 and the GNSS sensor(s) 758 may be combined in a single integrated unit.

The vehicle may include microphone(s) 796 placed in and/or around the vehicle 700. The microphone(s) 796 may be used for emergency vehicle detection and identification, among other things.

The vehicle may further include any number of camera types, including stereo camera(s) 768, wide-view camera(s) 770, infrared camera(s) 772, surround camera(s) 774, long-range and/or mid-range camera(s) 798, and/or other camera types. The cameras may be used to capture image data around an entire periphery of the vehicle 700. The types of cameras used depends on the embodiments and requirements for the vehicle 700, and any combination of camera types may be used to provide the necessary coverage around the vehicle 700. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 7A and FIG. 7B.

The vehicle 700 may further include vibration sensor(s) 742. The vibration sensor(s) 742 may measure vibrations of components of the vehicle, such as the axle(s). For example, changes in vibrations may indicate a change in road surfaces. In another example, when two or more vibration sensors 742 are used, the differences between the vibrations may be used to determine friction or slippage of the road surface (e.g., when the difference in vibration is between a power-driven axle and a freely rotating axle).

The vehicle 700 may include an ADAS system 738. The ADAS system 738 may include a SoC, in some examples. The ADAS system 738 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 760, LiDAR sensor(s) 764, and/or a camera(s). The ACC systems may include longitudinal ACC and/or lateral ACC. Longitudinal ACC monitors and controls the distance to the vehicle immediately ahead of the vehicle 700 and automatically adjust the vehicle speed to maintain a safe distance from vehicles ahead. Lateral ACC performs distance keeping, and advises the vehicle 700 to change lanes when necessary. Lateral ACC is related to other ADAS applications such as LCA and CWS.

CACC uses information from other vehicles that may be received via the network interface 724 and/or the wireless antenna(s) 726 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 700), while the I2V communication concept provides information about traffic further ahead. CACC systems may include either or both I2V and V2V information sources. Given the information of the vehicles ahead of the vehicle 700, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 760, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 760, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 700 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 700 if the vehicle 700 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 760, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 700 is backing up. Some RCTW systems include AEB to ensure that the vehicle brakes are applied to avoid a crash. RCTW systems may use one or more rear-facing RADAR sensor(s) 760, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 700, the vehicle 700 itself must, in the case of conflicting results, decide whether to heed the result from a primary computer or a secondary computer (e.g., a first controller 736 or a second controller 736). For example, in some embodiments, the ADAS system 738 may be a backup and/or secondary computer for providing perception information to a backup computer rationality module. The backup computer rationality monitor may run a redundant diverse software on hardware components to detect faults in perception and dynamic driving tasks. Outputs from the ADAS system 738 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 704.

In other examples, ADAS system 738 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 738 may be fed into the primary computer's perception block and/or the primary computer's dynamic driving task block. For example, if the ADAS system 738 indicates a forward crash warning due to an object immediately ahead, the perception block may use this information when identifying objects. In other examples, the secondary computer may have its own neural network which is trained and thus reduces the risk of false positives, as described herein.

The vehicle 700 may further include the infotainment SoC 730 (e.g., an in-vehicle infotainment system (IVI)). Although illustrated and described as a SoC, the infotainment system may not be a SoC, and may include two or more discrete components. The infotainment SoC 730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 700. For example, the infotainment SoC 730 may radios, disk players, navigation systems, video players, USB and Bluetooth connectivity, carputers, in-car entertainment, Wi-Fi, steering wheel audio controls, hands free voice control, a heads-up display (HUD), an HMI display 734, a telematics device, a control panel (e.g., for controlling and/or interacting with various components, features, and/or systems), and/or other components. The infotainment SoC 730 may further be used to provide information (e.g., visual and/or audible) to a user(s) of the vehicle, such as information from the ADAS system 738, autonomous driving information such as planned vehicle maneuvers, trajectories, surrounding environment information (e.g., intersection information, vehicle information, road information, etc.), and/or other information.

The infotainment SoC 730 may include GPU functionality. The infotainment SoC 730 may communicate over the bus 702 (e.g., CAN bus, Ethernet, etc.) with other devices, systems, and/or components of the vehicle 700. In some examples, the infotainment SoC 730 may be coupled to a supervisory MCU such that the GPU of the infotainment system may perform some self-driving functions in the event that the primary controller(s) 736 (e.g., the primary and/or backup computers of the vehicle 700) fail. In such an example, the infotainment SoC 730 may put the vehicle 700 into a chauffeur to safe stop mode, as described herein.

The vehicle 700 may further include an instrument cluster 732 (e.g., a digital dash, an electronic instrument cluster, a digital instrument panel, etc.). The instrument cluster 732 may include a controller and/or supercomputer (e.g., a discrete controller or supercomputer). The instrument cluster 732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 730 and the instrument cluster 732. As such, the instrument cluster 732 may be included as part of the infotainment SoC 730, or vice versa.

FIG. 7D is a system diagram for communication between cloud-based server(s) and the example autonomous vehicle 700 of FIG. 7A, in accordance with some embodiments of the present disclosure. The system 776 may include server(s) 778, network(s) 790, and vehicles, including the vehicle 700. The server(s) 778 may include a plurality of GPUs 784(A)-784(H) (collectively referred to herein as GPUs 784), PCIe switches 782(A)-782(D) (collectively referred to herein as PCIe switches 782), and/or CPUs 780(A)-780(B) (collectively referred to herein as CPUs 780). The GPUs 784, the CPUs 780, and the PCIe switches may be interconnected with high-speed interconnects such as, for example and without limitation, NVLink interfaces 788 developed by NVIDIA and/or PCIe connections 786. In some examples, the GPUs 784 are connected via NVLink and/or NVSwitch SoC and the GPUs 784 and the PCIe switches 782 are connected via PCIe interconnects. Although eight GPUs 784, two CPUs 780, and two PCIe switches are illustrated, this is not intended to be limiting. Depending on the embodiment, each of the server(s) 778 may include any number of GPUs 784, CPUs 780, and/or PCIe switches. For example, the server(s) 778 may each include eight, sixteen, thirty-two, and/or more GPUs 784.

The server(s) 778 may receive, over the network(s) 790 and from the vehicles, image data representative of images showing unexpected or changed road conditions, such as recently commenced road-work. The server(s) 778 may transmit, over the network(s) 790 and to the vehicles, neural networks 792, updated neural networks 792, and/or map information 794, including information regarding traffic and road conditions. The updates to the map information 794 may include updates for the HD map 722, such as information regarding construction sites, potholes, detours, flooding, and/or other obstructions. In some examples, the neural networks 792, the updated neural networks 792, and/or the map information 794 may have resulted from new training and/or experiences represented in data received from any number of vehicles in the environment, and/or based on training performed at a datacenter (e.g., using the server(s) 778 and/or other servers).

The server(s) 778 may be used to train machine learning models (e.g., neural networks) based on training data. In some embodiments, a facial feature key point estimation model 120 may be trained as described herein at least in part using server(s) 778. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 790, and/or the machine learning models may be used by the server(s) 778 to remotely monitor the vehicles.

In some examples, the server(s) 778 may receive data from the vehicles and apply the data to up-to-date real-time neural networks for real-time intelligent inferencing. The server(s) 778 may include deep-learning supercomputers and/or dedicated AI computers powered by GPU(s) 784, such as a DGX and DGX Station machines developed by NVIDIA. However, in some examples, the server(s) 778 may include deep learning infrastructure that use only CPU-powered datacenters.

The deep-learning infrastructure of the server(s) 778 may be capable of fast, real-time inferencing, and may use that capability to evaluate and verify the health of the processors, software, and/or associated hardware in the vehicle 700. For example, the deep-learning infrastructure may receive periodic updates from the vehicle 700, such as a sequence of images and/or objects that the vehicle 700 has located in that sequence of images (e.g., via computer vision and/or other machine learning object classification techniques). The deep-learning infrastructure may run its own neural network to identify the objects and compare them with the objects identified by the vehicle 700 and, if the results do not match and the infrastructure concludes that the AI in the vehicle 700 is malfunctioning, the server(s) 778 may transmit a signal to the vehicle 700 instructing a fail-safe computer of the vehicle 700 to assume control, notify the passengers, and complete a safe parking maneuver.

For inferencing, the server(s) 778 may include the GPU(s) 784 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808. In some embodiments, one or more functions of the facial feature key point detector 110 and/or facial feature key point estimation model 120 described herein may be performed at least in part using CPU(s) 806, GPU(s) 808 and/or logic unit(s) 820.

Examples of the logic unit(s) 820 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940. In some embodiments, one or more functions of the facial feature key point detector 110 and/or facial feature key point estimation model 120 described herein may be performed at least in part using data center 900.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof. In some embodiments, one or more functions of the facial feature key point detector 110 and/or facial feature key point estimation model 120 described herein may be performed at least in part using one or more node C.R.s 916(1)-916(N).

In at least one embodiment, as shown in FIG. 9, framework layer 920 may include a job scheduler 933, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use distributed file system 938 for large-scale data processing (e.g., “big data”). In at least one embodiment, job scheduler 933 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 933. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments. In some embodiments, one or more functions of the facial feature key point detector 110 and/or facial feature key point estimation model 120 described herein may be performed at least in part using software 932 and/or applications 942.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate a map of key point location confidence values for one or more feature key points based at least on one or more images of a subject;
determine, with respect to the map, a location of individual feature key points of the one or more feature key points based at least on a peak value of the key point location confidence values;
compute an occlusion score for at least one individual feature key point of the one or more feature key points based at least on a statistical distribution of the key point location confidence values;
generate a key point prediction based at least on the location of individual feature key points and the occlusion score for the at least one individual feature key point; and
control one or more operations of a vehicle based at least on the key point prediction.

2. The one or more processors of claim 1, wherein the one or more processors are further to correlate the location of individual feature key points with respect to the map with one or more key point locations with respect to the one or more facial images of the subject to generate the key point prediction.

3. The one or more processors of claim 1, wherein the one or more processors are further to generate the map on a per keypoint basis as a heat map wherein pixels represent one or more data channels, wherein pixel values in an individual data channel of the one or more data channels represents a respective key point location confidence value for a feature key point.

4. The one or more processors of claim 1, wherein the one or more processors are further to generate the map based on applying the one or more images to a feature key point estimation model.

5. The one or more processors of claim 4, wherein the feature key point estimation model is further to infer an occlusion classification based on at least one image of the one or more images and the map, wherein the occlusion classification indicates a type occlusion that is obscuring a feature key point of the one or more feature key points.

6. The one or more processors of claim 5, wherein the occlusion classification comprises one of: no occlusion, a self-occlusion, an object occlusion, or a truncated occlusion.

7. The one or more processors of claim 4, wherein the feature key point estimation model is trained using image training data wherein samples of the image training data comprise first annotations based on locations of the one or more feature key points and second annotations based on an indication of occlusion of the one or more feature key points.

8. The one or more processors of claim 4, wherein the feature key point estimation model is trained by optimizing the feature key point estimation model based at least on a key point location misalignment loss and a key point occlusion loss.

9. The one or more processors of claim 1, wherein the one or more processors are further to compute the statistical distribution based on a standard deviation to determine the key point location confidence values.

10. The one or more processors of claim 1, wherein the one or more images of the subject are captured by one or more image sensors comprising a red, green, blue (RGB) sensor, an infrared (IR) sensor, or an RGB-IR sensor.

11. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

12. A system comprising one or more processors to:
determine a location of individual feature key points of one or more feature key points based at least on a peak value of a heat map representing key point location confidence values;
compute an occlusion score for at least one individual feature key point of the one or more feature key points based at least on a statistical distribution of the key point location confidence values on the heat map; and
output key point prediction data based at least on the location of individual feature key points and the occlusion score for the at least one individual feature key point.

13. The system of claim 12, the one or more processors further to infer an occlusion classification for the at least one individual feature key point based at least on one or more facial images and the map, wherein the occlusion classification comprises one of: no occlusion, a self-occlusion, an object occlusion, or a truncated occlusion.

14. The system of claim 12, wherein the one or more processors are further to correlate the location of individual feature key points with respect to the map with one or more key point locations with respect to one or more facial images of a subject to generate the key point prediction data.

15. The system of claim 12, wherein the heat map representing key point location confidence values is generated using a machine learning model trained based at least on a two-dimensional feature key point data set and a three-dimensional feature key point data set comprising one or more two-dimensional projections of self-occluded feature key points.

16. The system of claim 12, further comprising a machine learning model trained to generate the heat map based at least on a key point location misalignment loss and an occlusion loss.

17. The system of claim 12, wherein the one or more processors are further to apply one or more labels to auto-annotate one or more facial images of a subject based on one or more inferences from the one or more facial images that indicate that the at least one individual facial feature key point is a self-occluded key point with an object occlusion.

18. The system of claim 12, wherein the one or more processors are further to generate the map as a heat map wherein pixels of the heat map represent one or more data channels, wherein an individual data channel of the one or more data channels represents a respective key point location confidence value for a facial feature key point.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

20. A method comprising:
generating key point prediction data representing one or more feature key points based at least on one or more facial images of a subject based at least on computing a peak value from a map of key point location confidence values inferred from the one or more facial images, and a statistical distribution based on a map of key point location confidence values.
